(19) United States
(12) Patent Application Publication
(10) Pub. No.: US 2008/0147758 A1
(43) Pub. Date: Jun. 19, 2008

(54) Variational Error Correction System and Method of Grid Generation

(75) Inventor: Shankar Subramaniam, Vernon, CT (US)

Correspondence Address: DOWNS RACHLIN MARTIN PLLC, 199 MAIN STREET, P O BOX 190, BURLINGTON, VT, 05402-0190, US

(73) Assignee: CONCEPTS ETI, INC., White River Junction, VT (US)

(21) Appl. No.: 11/958,209

(22) Filed: Dec. 17, 2007

Related U.S. Application Data
(60) Provisional application No. 60/870,263, filed on Dec. 15, 2006.
(60) Provisional application No. 60/953,198, filed on Jul. 31, 2007.

(51) Int. Cl. G06F 17/00; G06F 17/11; G06F 1/02

(52) U.S. Cl. 708/208; 708/446; 708/270

(57) ABSTRACT

A system and method for automatically generating a computation mesh for use with an analytical tool, the computation mesh having a plurality of ξ-grid lines and η-grid lines intersecting at grid points positioned with respect to an inner boundary and an outer boundary. The system and method include one or more mesh equations having one or more source terms that include: a grid clustering component based on a Jacobian scaling parameter, a source decay parameter, and one or more first point distance parameters, and a cell shape modifying source component based on one or more source parameters selected from the group consisting of a smoothing source parameter, an area source parameter, an orthagonality source parameter, and any combinations thereof.

### RELATED APPLICATION DATA

This application claims the benefit of priority of U.S. Provisional Patent Application Ser. No. 60/870,263, filed Dec. 15, 2006, and titled Automatic Elliptic Grid Generation, that is incorporated by reference herein in its entirety. This application also claims priority to U.S. Provisional Patent Application Ser. No. 60/953,198, filed Jul. 31, 2007, and titled Variational Error Correction System And Method Of Grid Generation. Each of these applications is incorporated herein by reference in its entirety.

This application is also related to commonly-owned U.S. patent application Ser. Nos. ______, entitled “First-Point Distance Parameter System and Method for Automatic Grid Generation;”, entitled “Jacobian Scaling Parameter System and Method for Automatic Grid Generation;” and ______, entitled “Source Decay Parameter System and Method for Automatic Grid Generation,” each of which are filed on the same day as this application: Dec. 17, 2007, each of which is incorporated herein in its entirety.

### FIELD OF THE INVENTION

The present invention generally relates to the field of automatic grid generation. In particular, the present invention is directed to a variational error system and method for automatic grid generation for use with analytical tools.

### BACKGROUND

Various techniques have been implemented for problems that require grid generation around complex geometries. Although these techniques achieve a certain level of success, they are often inadequate when faced with difficult geometries, such as, airfoils, turbine blades and other aerodynamically designed surfaces. Analyzing these shapes requires the most complex and time-consuming methodologies. Often, these methods use elliptic grid generation formulas that include variables selected and iteratively modified by the user in an effort to achieve the most ideal grid. Because these inputs are typically not completely independent, changes to one input will require modifications to others, thus increasing the permutations of manually entered selections necessary to generate a quality grid. Overall, the variability of these methods increases process time and ultimately impacts overall design and development operations. Additionally, certain elliptic grid generation methods fail to produce adequate computation meshes under certain conditions, such as course grid conditions and/or conditions where the boundary point distribution defining a shape to be analyzed lacked great definition. Such failures include mesh folding, wrinkles, and catastrophic collapse of mesh lines over a large part of the mesh domain. Improved grid generation techniques are desirable.

### SUMMARY OF THE DISCLOSURE

In one implementation, a computer-implemented method for automatically generating a computation mesh for use with an analytical tool, the computation mesh having a plurality of δ-grid lines and η-grid lines intersecting at grid points positioned with respect to an inner boundary and an outer boundary, is provided. The method includes receiving from a user information corresponding to a shape to be analyzed using the analytical tool; solving one or more mesh equations for a plurality of point locations, the one or more mesh equations having one or more source terms that include: a grid clustering component based on a Jacobian scaling parameter, a source decay parameter, and one or more first point distance parameters, and a cell shape modifying source component based on one or more source parameters selected from the group consisting of a smoothing source parameter, an area source parameter, an orthagonality source parameter, and any combinations thereof, generating the computation mesh as a function of the plurality of point locations; and outputting one or more indicia representing the computation mesh.

In another implementation, a system for automatically generating a computation mesh for use with an analytical tool, the computation mesh having a plurality of μ-grid lines and η-grid lines intersecting at grid points positioned with respect to an inner boundary and an outer boundary, is provided. The system includes a means for receiving from a user information corresponding to a shape to be analyzed using the analytical tool; a means for solving one or more mesh equations for a plurality of point locations, the one or more mesh equations having one or more source terms that include: a grid clustering component based on a Jacobian scaling parameter, a source decay parameter, and one or more first point distance parameters, and a cell shape modifying source component based on one or more source parameters selected from the group consisting of a smoothing source parameter, an area source parameter, an orthagonality source parameter, and any combinations thereof, a means for generating the computation mesh as a function of the plurality of point locations; and a means for outputting one or more indicia representing the computation mesh.

In still another implementation, a machine readable medium containing machine readable instructions for performing a method of automatically generating a computation mesh for use with an analytical tool, the computation mesh having a plurality of ξ-grid lines and η-grid lines intersecting at grid points positioned with respect to an inner boundary and an outer boundary, is provided. The instructions include a set of instructions for receiving from a user information corresponding to a shape to be analyzed using the analytical tool; a set of instructions for solving one or more mesh equations for a plurality of point locations, the one or more mesh equations having one or more source terms that include: a grid clustering component based on a Jacobian scaling parameter, a source decay parameter, and one or more first point distance parameters, and a cell shape modifying source component based on one or more source parameters selected from the group consisting of a smoothing source parameter, an area source parameter, an orthagonality source parameter, and any combinations thereof, a set of instructions for generating the computation mesh as a function of the plurality of point locations; and a set of instructions for outputting one or more indicia representing the computation mesh.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates one example of a computation mesh;

FIG. 2 illustrates an example of a step-wise approach for solving one or more mesh equations;

FIG. 3 illustrates one embodiment of a computer-implemented method generating a computation mesh;

FIG. 4 illustrates one example of grid points generated by a computation mesh generation method;

FIG. 5 illustrates one embodiment of a computing environment for implementing a method of generating a computation mesh;

FIG. 6 illustrates an exemplary turbine blade with an example of a computation mesh generated with one or more mesh equations;

FIG. 7 illustrates an exemplary turbine blade with an example of a computation mesh generated according to one implementation of the present disclosure;

FIG. 8 illustrates an exemplary turbine blade with an example of a computation mesh generated with one or more mesh equations;

FIG. 9 illustrates an exemplary turbine blade with an example of a computation mesh generated according to one implementation of the present disclosure;

FIG. 10 illustrates an exemplary turbine blade with an example of a computation mesh generated according to one implementation of the present disclosure;

FIG. 11 illustrates an exemplary turbine blade with an example of a computation mesh generated with one or more mesh equations;

FIG. 12 illustrates an exemplary turbine blade with an example of a computation mesh generated according to one implementation of the present disclosure;

FIG. 13 illustrates an exemplary turbine blade with an example of a computation mesh generated with one or more mesh equations;

FIG. 14 illustrates an exemplary turbine blade with an example of a computation mesh generated according to one implementation of the present disclosure;

FIG. 15 illustrates an exemplary turbine blade with an example of a computation mesh generated with one or more mesh equations;

FIG. 16 illustrates an exemplary turbine blade with an example of a computation mesh generated according to one implementation of the present disclosure;

FIG. 17 illustrates an exemplary turbine blade with an example of a computation mesh generated with one or more mesh equations;

FIG. 18 illustrates an exemplary turbine blade with an example of a computation mesh generated according to one implementation of the present disclosure;

FIG. 19 illustrates an example of an iterative method for solving one or more mesh equations;

FIGS. 20A to 20C illustrate an implementation of a computer-implemented method and system for automatically generating a computation mesh;

### DETAILED DESCRIPTION

In one aspect, a system and method are provided that include one or more mesh equations that have one or more source terms that include a grid clustering source component and a cell shape modifying source component. As will be discussed below, in one implementation the source terms and metric coefficients of one or more elliptic nonlinear Poisson grid generation equations are enhanced with the proper integration of one or more cell shape modifying source components, such as an area error correction, a smoothness error correction, and/or an orthagonality error correction. The one or more enhanced computation mesh equations are utilized in a computer implemented system and method to generate one or more computation meshes for a shape that is to be analyzed. In another implementation the enhanced computation mesh equations may include a Jacobian scaling parameter, a source decay parameter, and/or one or more first point distance parameters that enable the generation of a computation mesh with minimal input from a user. For example, a process of generating a computation mesh is made as automated as possible (e.g., the process does not require excessive interaction or additional modifications by a user of the computation mesh generation, such as the input of updated mesh parameters upon reiteration of one or mesh equations. Examples of a user modification, include, but are not limited to, a change to a source decay parameter, a change to a source term, a change to a first-point distance parameter, a change to a clustering parameter (e.g., a Kaul clustering parameter), and any combinations thereof. In another example, a fully automated process includes providing limited inputs to generate a computation mesh. Examples of inputs include, but are not limited to, a mesh parameter, a shape, and any combinations thereof. In one example, a computation mesh may be generated with only the input of information corresponding to a shape to be analyzed, a ξ-grid line mesh parameter value corresponding to a desired number of ξ-grid lines for the computation mesh, and an η-grid line mesh parameter value corresponding to a desired number of η-grid lines for the computation mesh. A computation mesh may include ξ-grid lines and η-grid lines intersecting in the space proximate a shape to be analyzed at grid points determined from one or mesh equations. ξ-grid lines and η-grid lines are discussed further below.

One or more mesh equations including source terms and metric coefficients with integrated cell shape modifying components are utilized to determine a grid location of one or more grid points of a computation mesh. A grid location is a position within a grid of a computation mesh. Examples of a grid location include, but are not limited to, a set of coordinates, a distance, and any combinations thereof. A computation mesh may be utilized to analyze a shape (e.g., a geometric representation, a feature, or other object). In one exemplary aspect, a computation mesh includes one or more ξ-grid lines and one or more η-grid lines that intersect at the one or more grid points of a grid of the computation mesh. The intersection of the ξ-grid lines and η-grid lines forms a plurality of grid cells having a cell area. The intersection of these lines includes the grid points of the mesh.

A computation mesh may provide a theoretical model for analyzing a shape and/or the region/space around the shape. It is readily appreciated that this theoretical model may be used to approximate one or more properties associated with one or more analytical methods. Examples of an analytical method include, but are not limited to, a computational fluid dynamics method, a finite element analysis method, a heat transfer modeling method, a stress/strain computational method, among others. A facet of each of the analytical methods is its reliance on the quality of the grid of a computation mesh. In one exemplary aspect, one or more mesh equations having a source term and metric coefficients with integrated cell shape modification components may provide a computation mesh with more uniformity of grid cell shape and area than with traditional elliptic grid generation techniques.

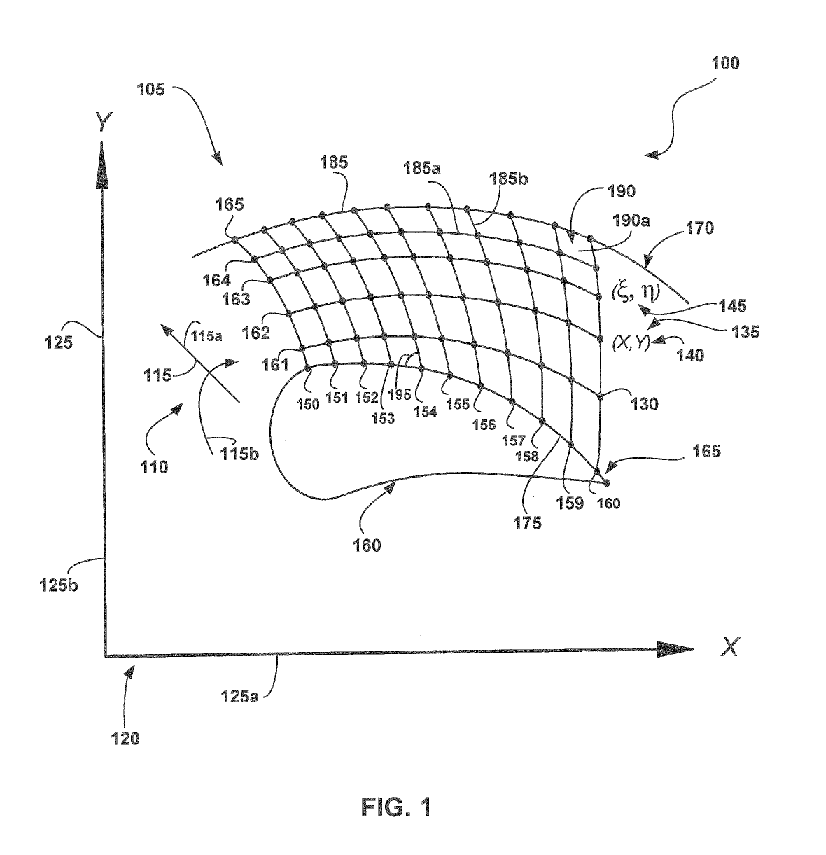

FIG. 1 illustrates an exemplary portion of a computation mesh 100 generated using one or more mesh equations as disclosed herein. Computation mesh 100 includes a space 105. A space is an area around the shape to be analyzed. Examples of a space include, but are not limited to, a computation space, a physical space, a spherical space, and any combinations thereof. In the present example, computation mesh 100 includes a computation space 110 having a set of computation axes 115, e.g., a ξ-axis 115a and a η-axis 115b. A set of computation axes provide a reference a set of computation coordinates (ξ, η). A set of computation coordinates (ξ, η) can have values that correspond to a set of numbers, a set of letters, and any combinations thereof. In one example, a set of computation coordinates (ξ, η) includes a set of numbers that are integers (e.g., 1, 2, 3, . . . ).

Computation mesh 100 also includes a physical space 120 that has a set of physical axes 125, e.g., x-axis 125a and y-axis 125b. A set of physical axes provide a reference for a set of physical coordinates (x,y). A set of physical coordinates (x,y) can have values that correspond to a set of numbers, a set of letters, and any combinations thereof. In one example, a set of physical coordinates (x,y) includes a set of numbers that are integers (e.g., 1, 2, 3, . . . ).

Computation mesh 100 includes a plurality of grid points 130. Each of the plurality of grid points 130 have a grid location 135. A grid location (e.g., grid location 135) is a position of a grid point in the space proximate the shape to be analyzed. Examples of a grid location include, but are not limited to, a set of physical coordinates (x,y), a set of computation coordinates (ξ,η), a set of spherical coordinates, and any combinations thereof. In a computational domain, η₁ typically represents the minimum value of η, η_{M} represents the maximum value of η, ξ₁ represents the minimum value of ξ, and ξ_{N} represents the maximum value of ξ. The letter “N” may correspond to a mesh parameter having a value representing a number of η-grid lines. The letter “M” may correspond to a mesh parameter having a value representing a number of ξ-grid lines. In one example, a grid location is a set of physical coordinates (x,y) 140. In another example, a grid location is a set of computation coordinates (ξ,η) 145.

In one implementation, one or more elliptic grid generation equations are integrated with one or more cell shape modifying components. In one example, the one or more elliptic grid generation equations include a coupled set of nonlinear Poisson equations used to determine the position of a grid point within the grid of a computation mesh. These nonlinear Poisson equations can be expressed as follows:

ξₓₓ+ξ_{yy}=P Equation (1)

ηₓₓ+η_{yy}=Q Equation (2)

where ξₓₓ, ξ_{yy}, ηₓₓ and η_{yy} are second-order derivates that, as described in detail below, are used to define grid locations. The right hand side of the equations are the source terms, e.g., source terms P and Q. A source term defines a grid position of a grid point of a computation mesh. A grid position is the disposition of a grid point within a space. As mentioned above, a space can be a physical space and a computation space, among others. In one example, source terms P and Q define a position within a computation space. In another example, to define a position, source terms P and Q are expressed in terms of a set of computation coordinates (ξ,η), e.g., P(ξ,η) and Q(ξ,η).

Equations (1) and (2) may be expressed as with the source terms (P^{(x)}x_{ξ}+Q^{(x)}x_{η}) and (P^{(y)}y_{ξ}+Q^{(y)}y_{η}) moved to the left hand side of the equation:

G₂₂^{(x)}x_{ξξ}+G₁₁^{(x)}x_{ηη}=2G₁₂^{(x)}x_{ξη}+(P^{(x)}x_{ξ}+Q^{(x)}x_{η})=0 Equation (3)

G₂₂^{(y)}y_{ξξ+G}₁₁^{(y)}y_{ηη}−2G₁₂^{(y)}y_{ξη}+(P^{(y)}y_{ξ}+Q^{(y)}y_{η})=0 Equation (4)

where P^{(x)}, P^{(y)}, Q^{(x)} and Q^{(y)} are generalized source terms and G₁₁^{(x)}, G₁₂^{(x)}, G₂₂^{(x)}, G₁₁^{(y)}, G₁₂^{(y)}, G₂₂^{(y)} are generalized metric coefficients. A generalized source term (e.g., generalized source terms P^{(x)}, P^{(y)}, Q^{(x)} and Q^{(y)}), like source terms P and Q above, define a grid position of a grid point of a computation mesh. The integration of elliptic grid clustering components and cell shape modifying components of the metric coefficients and source terms are discussed in the definitions of each below. The generalized metric terms may be represented as:

G₁₁^{(x)}=W_{S}g₁₁+W_{A}y_{ξ}²+W_{O}x_{ξ}² Equation (5)

G₁₂^{(x)}=W_{S}g₁₂+W_{A}y_{ξ}y_{η}+W_{O}(−g₁₂−x_{ξ}x_{η}) Equation (6)

G₂₂^{(x)}=W_{S}g₂₂+W_{A}y_{η}²+W_{O}x_{η}² Equation (7)

G₁₁^{(y)}=W_{S}g₁₁+W_{A}x_{ξ}²+W_{O}y_{ξ}² Equation (8)

G₁₂^{(y)}=W_{S}g₁₂+W_{A}x_{ξ}x_{η}+W_{O}(−g₁₂−y_{ξ}y_{η}) Equation (9)

G₂₂^{(y)}=W_{S}g₂₂+W_{A}x_{η}²+W_{O}y_{η}² Equation (10)

where W_{S}, W_{A}, and W_{O} are parameters of the cell shape modifying components (where W_{S} is a smoothing source parameter, W_{A} is an area source parameter, W_{O} is an orthagonality source parameter). The left hand side of the metric equations include components of elliptic grid clustering and cell shape modifying elements integrated together with the smoothing, area and orthagonality source parameters.

The generalized source terms P^{(x)}, P^{(y)}, Q^{(x)} and Q^{(y)} can be written as:

P^{(x)}=W_{S}p_{S}^{(x)}+W_{A}(y_{η}y_{ξη}−y_{ξ}y_{ηη})+W_{O}(y_{η}y_{ξη}+y_{ξ}y_{ηη}) Equation (11)

P^{(y)}=W_{S}p_{S}^{(y)}+W_{A}(x_{η}x_{ξη}−x_{ξ}x_{ηη})+W_{O}(x_{η}x_{ξη}+x_{ξ}x_{ηη}) Equation (12)

Q^{(x)}=W_{S}q_{S}^{(x)}+W_{A}(y_{ξ}y_{ξη}−y_{η}y_{ξξ})+W_{O}(y_{ξ}y_{ξη}+y_{η}y_{ξξ}) Equation (13)

Q^{(y)}=W_{S}q_{S}^{(y)}+W_{A}(x_{ξ}x_{ξη}−x_{η}x_{ξξ})+W_{O}(x_{ξ}y_{ξη}+x_{η}x_{ξξ}) Equation (14)

where W_{S} is a smoothing source parameter; W_{A} is an area source parameter; W_{O} is an orthagonality source parameter; and p_{S}^{(x)}, q_{S}^{(x)}, p_{S}^{(y)} and q_{S}^{(y)} are grid clustering source components. A grid clustering source is determined as a function of a grid location relative to an inner boundary, an outer boundary and any combination thereof. Examples of a source include, but are not limited to, a variable, a function an algorithm and any combination thereof. The left hand side of the source term equations include components of elliptic grid clustering and cell shape modifying elements integrated together with the smoothing, area and orthagonality source parameters.

In one example, the grid clustering source components are defined as:

p_{S}^{(x)}=p(ξ)e^{-a(ξ)(η-η}^{₁}⁾+r(ξ)e^{-b(ξ)(η}^{_{M}}^{-η)} Equation (15)

q_{S}^{(x)}=p(ξ)e^{-c(ξ)(η-η}^{₁}⁾+s(ξ)e^{-d(ξ)(η}^{_{M}}^{-η)} Equation (16)

p_{S}^{(y)}=p(ξ)e^{-a(ξ)(η-η}^{₁}⁾+r(ξ)e^{-b(ξ)(η}^{_{M}}^{-η)} Equation (17)

q_{S}^{(y)}=q(ξ)e^{-c(ξ)(η-η}^{₁}⁾+s(ξ)e^{-d(ξ)(η}^{_{M}}^{-η)} Equation (18)

where a(ξ), b(ξ), c(ξ), d(ξ) are source decay parameters defined at a value of computation coordinate ξ; p(ξ), q(ξ), r(ξ) and s(ξ) are sources; η is a number having a value of computation coordinate η; η₁ is a number having a value of η proximate the inner boundary along the η-grid lines; and η_{M} is a number having a value proximate the inner boundary along the η-grid line.

In another example, the grid clustering source components are defined as:

p_{S}^{(x)}=p(ξ)e^{-k(ξ)(η-η}^{₁}⁾+r(ξ)e^{-k(ξ)(η}^{_{M}}^{-η)} Equation (19)

q_{S}^{(x)}=q(ξ)e^{-k(ξ)(η-η}^{₁}⁾+s(ξ)e^{-k(ξ)(η}^{_{M}}^{-η)} Equation (20)

p_{S}^{(y)}=p(ξ)e^{-k(ξ)(η-η}^{₁}⁾+r(ξ)e^{-k(ξ)(η}^{_{M}}^{-η)} Equation (21)

q_{S}^{(y)}=q(ξ)e^{-k(ξ)(η-η}^{₁}⁾+s(ξ)e^{-k(ξ)(η}^{_{M}}^{-η)} Equation (22)

where k is a source decay factor that is proportional to a source decay parameter and inversely proportional to the number of η-grid lines of the computation mesh (e.g., k=source decay parameter σ divided by M, the number of η-grid lines of the computation mesh; p(ξ), q(ξ), r(ξ) and s(ξ) are sources; η is a number having a value of a computation coordinate η; η₁ is a number having a value of η proximate the inner boundary along the ξ-grid lines; and η_{M} is a number having a value proximate the inner boundary along the ξ-grid line.

In one exemplary aspect, a source decay parameter is a variable that moderates the one or more mesh equations so as to cause the grid points to be evenly spaced. Examples of a source decay parameter include, but are not limited to, a variable, a number, an integer, a function, a mathematical algorithm and any combinations thereof. In one example, a source decay parameter is an integer selected at random. In another example, a source decay parameter is an integer determined for each value of computational coordinate ξ. In still another example, a source decay parameter is an integer equal to one. In one example, source decay parameter σ has a value from about 8 to about 16. In another example, source decay parameter σ has a value from 8 to 16. In yet another example, source decay parameter σ has a value equal to about 14. In still yet another example, source decay parameter σ has a value equal to 14. In one exemplary aspect, a decay of a source term defined as e^{-σ(η-η}^{₁}^{)/M} allows for a source term to remain constant for each grid point calculation (e.g., for each set of computational coordinates (ξ,η)).

Sources, such as p(ξ), q(ξ), r(ξ) and s(ξ) are sources, can be determined via elliptic grid generation techniques. Examples of a source include, but are not limited to, a variable, a function, an algorithm and any combinations thereof. In one example, sources p(ξ) and q(ξ) are terms determined relative to an inner boundary as:

$$\begin{matrix}{J}^{2} p ( ξ ) = {{( \frac{J}{{J}_{1}} )}^{2} [ {R}_{1} \frac{{y}_{η}}{{J}_{1}} - {R}_{2} \frac{{x}_{η}}{{J}_{1}} ]}_{{η}_{1}} & Equation ( 23 ) \\ {J}^{2} q ( ξ ) = {{( \frac{J}{{J}_{1}} )}^{2} [ - {R}_{1} \frac{{y}_{ξ}}{{J}_{1}} + {R}_{2} \frac{{x}_{ξ}}{{J}_{1}} ]}_{{η}_{1}} . & Equation ( 24 )\end{matrix}$$

and sources r(ξ) and s(ξ) are variables determined relative to an outer boundary as:

$$\begin{matrix}{J}^{2} r ( ξ ) = {{( \frac{J}{{J}_{M}} )}^{2} [ {R}_{3} \frac{{y}_{η}}{{J}_{M}} - {R}_{4} \frac{{x}_{η}}{{J}_{M}} ]}_{{η}_{M}} & Equation ( 25 ) \\ {J}^{2} s ( ξ ) = {{( \frac{J}{{J}_{M}} )}^{2} [ - {R}_{3} \frac{{y}_{ξ}}{{J}_{M}} + {R}_{4} \frac{{x}_{ξ}}{{J}_{M}} ]}_{{η}_{M}} & Equation ( 26 )\end{matrix}$$

where J is a Jacobian defining a cell area of a grid cell located within the interior of a grid of a computation mesh; J₁ identifies a Jacobian evaluated at an inner boundary; J_{M} identifies a Jacobian evaluated at an outer boundary; and R₁, R₂, R₃ and R₄ are functions of the first-order and second order-derivates that describe the shape of the ξ-grid lines and η-grid lines. In particular, each of the ξ-grid lines and η-grid lines include a curvature determined, in part, on the location of each of the grid points along the ξ-grid or η-grids. In one example, the curvature is defined as:

R₁=−└g₂₂x_{ξξ}−2g₁₂x_{ξη}+g₁₁x_{ηη}┘_{η}_{₁} Equation (27)

R₂=−└g₂₂y_{ξξ}−2g₁₂y_{ξη}+g₁₁y_{ηη}┘_{η}_{₁} Equation (28)

R₃=−└g₂₂x_{ξξ}−2g₁₂x_{ξη}+g₁₁x_{ηη}┘_{η}_{_{M}} Equation (29)

R₄=−└g₂₂y_{ξξ}−2g₁₂y_{ξη}+g₁₁y_{ηη}┘_{η}_{_{M}} Equation (30)

In another example, sources p(ξ) and q(ξ) are variables determined relative to an inner boundary as:

$$\begin{matrix}{J}^{2} p ( ξ ) = {{( \frac{J}{{J}_{1}} )}^{λ} [ {R}_{1} \frac{{y}_{η}}{{J}_{1}} - {R}_{2} \frac{{x}_{η}}{{J}_{1}} ]}_{{η}_{1}} & Equation ( 31 ) \\ {J}^{2} q ( ξ ) = {{( \frac{J}{{J}_{1}} )}^{λ} [ - {R}_{1} \frac{{y}_{ξ}}{{J}_{1}} + {R}_{2} \frac{{x}_{ξ}}{{J}_{1}} ]}_{{η}_{1}} & Equation ( 32 )\end{matrix}$$

and sources r(ξ) and s(ξ) are variables determined relative to an outer boundary as:

$$\begin{matrix}{J}^{2} r ( ξ ) = {{( \frac{J}{{J}_{M}} )}^{λ} [ {R}_{3} \frac{{y}_{η}}{{J}_{M}} - {R}_{4} \frac{{x}_{η}}{{J}_{M}} ]}_{{η}_{M}} & Equation ( 33 ) \\ {J}^{2} s ( ξ ) = {{( \frac{J}{{J}_{M}} )}^{λ} [ - {R}_{3} \frac{{y}_{ξ}}{{J}_{M}} + {R}_{4} \frac{{x}_{ξ}}{{J}_{M}} ]}_{{η}_{M}} & Equation ( 34 )\end{matrix}$$

where J identifies a Jacobian defining a cell area of a grid cell located within the interior of a grid of a computation mesh; J₁ identifies a Jacobian evaluated at an inner boundary; J_{M} identifies a Jacobian evaluated at an outer boundary; λ identifies a Jacobian scaling parameter having a value that is not equal to two; and R₁, R₂, R₃ and R₄ are curvature terms (e.g., a term that influences the shape and position of ξ-grid lines and η-grid lines). In particular, each of the ξ-grid lines and η-grid lines include a curvature determined, in part, on the location of each the grid points along the ξ-grid or η-grids. In one example, the curvature is defined as:

R₁=−└g₂₂x_{ξξ}−2g₁₂x_{ξη}+g₁₁x_{ηη}┘_{η}_{₁} Equation (35)

R₂=−└g₂₂y_{ξξ}−2g₁₂y_{ξη}+g₁₁y_{ηη}┘_{η}_{₁} Equation (36)

R₃=−└g₂₂x_{ξξ}−2g₁₂x_{ξη}+g₁₁x_{ηη}┘_{η}_{_{M}} Equation (37)

R₄=−└g₂₂y_{ξξ}−2g₁₂y_{ξη}+g₁₁y_{ηη}┘_{η}_{_{M}} Equation (38)

A Jacobian scaling parameter, λ, may include any value that is not equal to two. Examples of a value for λ that does not equal two include, but are not limited to, a variable, a formula, an algebraic expression, an integer, a fraction, other number, or any combination thereof. In one example, λ is a variable that may be assigned a value. In another example, λ is a fixed value for operation with one or more mesh equations. In yet another example, λ has a value from about 0.5 to about less than 2. In still another example, λ has a value from 0.5 to 2. In still yet another example, λ has a value of about 1.25. In a further example, λ has a value of 1.25.

In one implementation, one or more first-point distance parameters, e.g., the inner boundary distance parameter D₁ and the outer boundary distance parameter D_{M}, relate to one or more mesh equations via sources p, q, r and s and the dependence of sources p, q, r and s as described above on the second-order derivates ηₓₓ and η_{yy} and with the first-order derivates x_{η} and y_{η}. A grid location defined by first-order derivates x_{η} and y_{η} can be expressed in terms of the first-order derivates x_{ξ} and y_{ξ} along an inner boundary. While it is contemplated that several variations of expressions of x_{η} and y_{η} may exist, examples of a first order derivate along an inner boundary are illustrated as:

$$\begin{matrix}{[ {x}_{η} ]}_{{η}_{1}} = {[ {D}_{1} ( ξ ) \frac{- {x}_{ξ} cos θ - {y}_{ξ} sin θ}{\sqrt{{g}_{11}}} ]}_{{η}_{1}} & Equation ( 39 ) \\ {[ {y}_{η} ]}_{{η}_{1}} = {[ {D}_{1} ( ξ ) \frac{- {y}_{ξ} cos θ - {y}_{ξ} sin θ}{\sqrt{{g}_{11}}} ]}_{{η}_{1}} & Equation ( 40 )\end{matrix}$$

First-order derivates x_{η} and y_{η} can also be expressed in terms of the first-order derivate x_{ξ} and y_{ξ} along an outer boundary. While it is contemplated that several variations of expressions of x_{η} and y_{η} may exist, examples of a first-order derivates along an outer boundary are illustrated as:

$$\begin{matrix}{[ {x}_{η} ]}_{{η}_{M}} = {[ {D}_{M} ( ξ ) \frac{- {x}_{ξ} cos θ - {y}_{ξ} sin θ}{\sqrt{{g}_{11}}} ]}_{{η}_{M}} & Equation ( 41 ) \\ {[ {y}_{η} ]}_{{η}_{M}} = {[ {D}_{M} ( ξ ) \frac{- {y}_{ξ} cos θ - {y}_{ξ} sin θ}{\sqrt{{g}_{11}}} ]}_{{η}_{M}} & Equation ( 42 )\end{matrix}$$

where θ is an angle between a ξ-grid line and a boundary, e.g., an inner boundary and an outer boundary. D₁(ξ) is an inner boundary distance parameter defined at a value of computation coordinate ξ. Each of D₁ and D_{M} may be determined by any known method of determining a first-point distance parameter.

In one aspect, a first-point distance parameter may influence a spatial location for a grid point of a computation mesh. A grid location is a spatial position within a computation domain of interest in a space proximate a shape to be analyzed. Examples of a grid location include, but are not limited to, a set of coordinates, a distance, a fraction of the overall length scale of the computation domain of interest and any combinations thereof. In one example, a first-point distance parameter determines a grid location in relation to one or more boundaries. A boundary may include an extremity of a grid of a computation mesh. Examples of a boundary include, but are not limited to, an inner boundary, an outer boundary, a specified interior portion of a computation domain of interest, and any combinations thereof. An inner boundary may include an inside portion of a grid of a computation mesh. In one example, an inner boundary is the outside edge of a shape being analyzed. In one such example, information corresponding to a shape may be provided as a plurality of data points that may be used to define an inner boundary. An outer boundary may include an outside portion of a grid of a computation mesh. In one example, an outer boundary is the outside edge of a computation mesh being generated. In one such example, an outer boundary may include a number of data points (e.g., grid points) that may be used to define the outer boundary. A first-point distance parameter that influences a grid location in relation to an inner boundary may be referred to as an inner boundary distance parameter. A first-point distance parameter that influences a grid location in relation to an outer boundary may be referred to as an outer boundary distance parameter.

In one example, an automated first-point distance parameter is a first-point distance parameter that allows for automation with respect to a first-point distance determination in a generation of a computation mesh as described herein.

In one embodiment, an outer boundary distance parameter D_{M} varies as a function of an inner boundary distance parameter D₁:

D_{M}=F*D₁ Equation (43)

where F is a function of the number of grid points along the ξ-grid lines (where the number of grid points along the ξ-grid lines may be referred to as M):

D_{M}=F(M)*D₁. Equation (44)

In one example, F(M) is defined as:

F(M)=ln(M), Equation (45)

where ln(M) is the natural log of M. Use of a relationship between D_{M} and D₁ that involves F(M) including the natural log of M may be referred to herein as log scaling.

In another example, F(M) is defined as an approximation of ln(M) which, as M increases, F(M) increases at a pace slightly faster than ln(M). In one such example, an approximation of ln(M) is satisfied by M^{v}, where v is an exponent of M having a value of about 0.2 to about 0.8 (eg, M^{0.2}, M^{0.3}, M^{0.4}, M^{0.5}, M^{0.6}, M^{0.7}, M^{0.8}). In another such example, an approximation of ln(M) is satisfied by M^{v}, where v is an exponential of M having a value of about 0.3 to about 0.7 (e.g., M^{0.3}, M^{0.4}, M^{0.5}, M^{0.6}, M^{0.7}). In yet another such example, an approximation of ln(M) is satisfied by M^{v}, where v is an exponential of M having a value of about 0.4 to about 0.6 (e.g., M^{0.4}, M^{0.5}, M^{0.6}). In still yet another such example, an approximation of ln(M) is satisfied by M^{v}, where v is an exponential of M having a value of about 0.5 (e.g., M^{0.45}, M^{0.5}, M^{0.55}).

In yet another example, F(M) is defined as:

F(M)=\sqrt{M}, Equation (46)

where \sqrt{M} is the square root of M. Use of a relationship between D_{M} and D₁ that involves F(M) including the square root of M may be referred to herein as square root scaling.

The number of grid points along the ξ-grid lines (M) can be determined in a variety of ways. In one example, the shape to be analyzed establishes the value of M. In another example, a desired number of grid cells establishes the value of M. In still another example, the value of M is determined according to an end user preference. A ξ-grid line mesh parameter may include a value that is the number of grid points along the ξ-grid lines. In one example, a ξ-grid line mesh parameter is provided to one or more mesh equations.

Inner boundary distance parameter D₁ can be defined in a number of ways. In one example, inner boundary distance parameter D₁ is a local inner boundary distance parameter D₁(ξ)_{LOC}. A local inner boundary distance parameter D₁(ξ)_{LOC} is determined by dividing the length of a ξ-grid line by the number of points along that ξ-grid line (M). The length of a ξ-grid line can be determined in a variety of ways. In one example, the length is a straight-line distance between the inner boundary of the computation mesh and the outer boundary of the computation mesh. In another example, the length of the ξ-grid line is an actual length of the ξ-grid line (e.g., a non-straight ξ-grid line) between the inner boundary of the computation mesh and the outer boundary of the computation mesh. In still another example, the length of the ξ-grid line is the distance between the point formed by the intersection of the ξ-grid line and an inner boundary of the computation mesh to the point formed by the intersection of the ξ-grid line and an outer boundary of the computation mesh. In yet another example, the length of the ξ-grid line is the distance between the point formed by the intersection of the ξ-grid line and an inner boundary of the computation mesh to the point formed by the intersection of the ξ-grid line and an outer boundary of the computation mesh running along the ξ-grid line itself.

In another example, inner boundary distance parameter D₁ is a global inner boundary distance parameter D₁(ξ)_{GBL}. A global inner boundary distance parameter D₁(ξ)_{GBL} is determined by summing the local inner boundary distance parameter D₁(ξ)_{LOC} for each value of computation coordinate ξ and dividing by the number of grid points along the η-grid lines (where the number of grid points along the η-grid lines may be referred to as N).

In another implementation, determination of when to use a global inner boundary distance parameter or a local inner boundary distance parameter for D₁ can be made based on whether the number of grid points along the ξ-grid lines (M) [e.g., the number of η-grid lines] exceeds a threshold resolution parameter. A threshold resolution parameter is a parameter used to distinguish between a desired computation mesh having a high concentration of grid cells positioned between the inner boundary and the outer boundary (e.g., a fine mesh) and a desired computation mesh having a low concentration of grid cells positioned between the inner boundary and the outer boundary (e.g., a course mesh). A threshold resolution parameter value may be determined in a variety of ways. In one example, such a threshold resolution parameter may be dictated by a desired outcome and/or performance characteristics for a given shape with relation to a particular set of one or more mesh equations. In one such example, a threshold resolution parameter value is about 20. In another example, a threshold resolution parameter value is 20. In yet another example, a threshold resolution parameter value is about 40. In still another example, a threshold resolution parameter value is 40. In still yet another example, a threshold resolution parameter value is about 50. In a further example, a threshold resolution parameter value is 50. In still a further example, a threshold resolution parameter value is determined by a desired length of individual grid cells along a ξ-grid line in relation to the total length of a ξ-grid line (e.g., a percentage, such as less than about 1%).

A threshold resolution parameter may be applied in a variety of ways. In one example, a threshold resolution parameter may be fixed for all computation mesh generations. In another example, a threshold resolution parameter may be variable. In such a variable threshold resolution parameter, a user may enter one or more values that influence the value of the variable threshold resolution parameter.

In one implementation, if M exceeds a threshold resolution parameter, an inner boundary distance parameter D₁ is a local inner boundary distance parameter; and if M does not exceed the threshold resolution parameter, the inner boundary distance parameter D1 is a global inner boundary distance parameter.

In another implementation, if M exceeds a threshold resolution parameter, an outer boundary distance parameter D_{M} may be a function of an inner boundary distance parameter and the natural log of M. In one example, D₁ is a global inner boundary distance parameter. In another example, D₁ is a local inner boundary distance parameter.

In yet another implementation, if M does not exceed a threshold resolution parameter, an outer boundary distance parameter D_{M} may be a function of an inner boundary distance parameter and the square root of M. In one example, D₁ is a global inner boundary distance parameter. In another example, D₁ is a local inner boundary distance parameter.

In still yet another implementation, if M does not exceed a threshold resolution parameter, an outer boundary distance parameter D_{M} may be a function of an inner boundary distance parameter and an approximation of the natural log of M (e.g., M^{v}) In one example, D₁ is a global inner boundary distance parameter. In another example, D₁ is a local inner boundary distance parameter.

Exceeding a threshold parameter (or other value) may be determined in a variety of ways and may depend on the individual value of the threshold parameter. In one example, exceeding a threshold parameter includes any value that is greater than the threshold parameter value. In another example, exceeding a threshold parameter includes any value that is greater than or equal to the threshold parameter value.

As discussed above, cell shape modifying components may include source parameters, such as a smoothness error correction, an area error correction, and an orthogonality error correction. In one example, a smoothness adjustment measures a smoothness quality and modifies the grid location of one or more grid points. A smoothness quality is directed at the spacing between the ξ-grid lines and between the η-grid lines of the grid of a computation mesh. In another example, an orthagonality adjustment measures an orthagonality quality and modifies the grid location of one or more grid points. An orthagonality quality is directed at the orthagonality between ξ-grid lines and the η-grid lines of the grid of a computation mesh. In still another example, an area adjustment measures an area quality and modifies the grid location of one or more grid points. An area quality is directed at the uniformity of the cell area of the grid cells of the grid of a computation mesh. A smoothness, area, and/or orthogonality source parameter may have values that weight the influence of the cell shape modifying impact in the one or more source terms. In one example, the values of the cell shape modifying source parameters may be 0≦[W_{S}, W_{A}, W_{O}]≦1. In another example, the smoothing source parameter has a value of 1, the area source parameter has a value of 0.5, and the orthagonality source parameter has a value of 0.15. In yet another example, the values of these cell shape modifying source parameters may be set via experimentation to modify a quality (e.g., smoothness, area, orthogonality) of a computation mesh. In still another example, a value of a cell shape modifying source parameter may have a value that is normalized so as to cause the values of all the weight factors (e.g., source parameters) in a combination of variational error correction to add up to about one. By adjusting the influence of each variational error correction, an exemplary one or more mesh equations with source terms integrating a grid clustering component and a cell shape modifying component may be tailored to adjust one or more qualities of the grid of a computation mesh.

A cell shape modifying component can be expressed in a variety of ways. Examples of a cell shape modifying component include, but are not limited to, a variable, an algorithm, an algebraic expression, a functional and any combinations thereof. In one example, a cell shape modifying component includes a smoothness error functional. A smoothness error functional measures a smoothness quality for the mapping between, e.g., a computation space and a physical space. An example of a smoothness functional is:

$${I}_{S} = \int \int \frac{{x}_{ξ}^{2} + {x}_{η}^{2} + {y}_{ξ}^{2} + {y}_{η}^{2}}{J} d ξ d η \qquad Equation ( 47 )$$

where dξ and dη are derivatives that define the change in a set of computation coordinates (e.g., computation coordinate 145); x_{ξ}, x_{η}, y_{ξ} and y_{η} are first-order derivatives that, as described in detail herein, are used to define one or more grid locations; and the term J is a Jacobian term that includes the first-order derivatives. An example of a Jacobian includes, but is not limited to:

J≡x_{ξ}y_{η}−x_{η}y_{ξ}. Equations (48)

In another example, a cell shape modifying component includes an orthagonality error functional. An orthagonality error functional measures the orthagonality quality between one or more ξ-grid lines and one or more η-grid lines. An example of an orthagonality error functional is:

I_{O}=∫∫(x_{ξx}_{η}+y_{ξy}_{η})²dξdη. Equation (49)

In still another example, a cell shape modifying component includes an area error functional. An area error functional measures the area quality of the grid cells of a grid of a computation mesh. An example of an area error functional is:

I_{A}=∫∫J²dξdη. Equation (50)

In one aspect one or more variational error corrections can be written as:

I=W_{S}I_{S}+W_{A}I_{A}+W_{O}I_{O} Equation (51)

where I_{S} is the smoothness error functional, I_{A} is the area error functional and I_{O} is the orthagonality error functional

In one aspect, although the uniformity of each of the grid cells along one or more boundaries of a computation mesh is important, the measure of the quality of a grid depends on several factors. Indeed, visual inspection of the grid cells within a grid of a computation mesh does not provide a reasonable means of assessing the quality of a grid. Instead, several criteria are used that, for the most part, indicate when the quality of a grid is not good. These factors include, among others:
A high degree of skewness;
An abrupt change in grid spacing;
An insufficient grid line continuity;
The nonalignment of the grid with the flow;
An insufficient resolution to resolve proper physical length scales;
The grid lacks special features needed by physical sub-models;
The grid is not singularity free.

### A computation mesh generated using one or more mesh equations including one or more source terms having a grid clustering component and a cell shape modifying component provide improvements to one or more of these factors.

The layout of a particular computation mesh may be dictated by one or more mesh parameters. A mesh parameter is a variable or other value that defines one or more facets of the computation mesh. Examples of a mesh parameter include, but are not limited to, a variable, a number, a mathematical function and any combinations thereof. In one example, a mesh parameter is the total number of grid points. In another example, a mesh parameter is the number of grid points on a ξ-grid lines (M). In still another example, a mesh parameter is the number of grid points on a η-grid line (N). It should be noted that where a value of M and/or N is provided, it is contemplated that the provided value for each of M and/or N may be the number of grid points along the corresponding line plus or minus an integer (e.g., 1, 2, etc) and the concepts of provided values of M and/or N as used herein (and the corresponding mathematical manipulation required to determine the appropriate number of points) includes such a variation.

In still yet another example, a mesh parameter depends on the value of the number of grid cells along a ξ-grid lines (e.g., a value of the number of grid cells plus one). In a further example, a mesh parameter depends on the value of the number of grid cells along a η-grid line (e.g., a value of the number of grid cells plus one).

Referring back to FIG. 1, an embodiment 100 of a portion of a computation mesh 100 generated utilizing a method for generating a computation mesh as described herein is illustrated. In this example, the number of grid points along the ξ-grid lines (M) is 6 and the number of grid points along the η-grid lines (N) is 11. The values of M and N may vary depending on the implementation. In another example, the number of grid points along the ξ-grid lines (M) can vary from 5 to 300 and the number of grid points along the ξ-grid lines (N) is can vary from 10 to 150. FIG. 1 also includes a shape 160. A shape (e.g., shape 160) can be any shape, form, profile or other feature for analysis using the analytical tools mentioned above. Examples of such a shape include, but are not limited to, a symmetric airfoil, an asymmetric airfoil, an Oval of Cassini, a turbine blade, a cascade, and any combinations thereof. Moreover, although discussed in connection with two-dimensional mesh generation, it is contemplated that the generation techniques disclosed herein (e.g., in conjunction with shape 160) include shapes having more than two dimensions. Examples of some applicable multi-dimensional shapes include, but are not limited to, an airfoil, a wing, a turbine blade, and any combinations thereof.

Computation mesh 100 also includes an inner boundary 165 and an outer boundary 170. In one example, inner boundary 165 corresponds with an outer edge 175 of shape 160. As illustrated in FIG. 1, outer boundary 170 is spaced in relation to inner boundary 165. In one example, outer boundary 170 is the outer edge of computation mesh 180 with a contour that corresponds with the contour of inner boundary 165. It is further contemplated that an inner boundary (e.g., inner boundary 165) and an outer boundary (e.g., outer boundary 170) may each encompass any shape, form, and/or curvature. Such shape, form, and/or curvature may be influenced, for example, by the object shape being analyzed, one or more analytical tool characteristics, a characteristic of the space proximate the object shape being analyzed, other consideration, and any combinations thereof.

Computation mesh 100 further includes a plurality of grid lines 185, such as η-grid lines 185a and ξ-grid lines 185b. As displayed in the present example, grid lines (e.g., ξ-grid line 185a and η-grid line 185b) connect one or more of the plurality of grid points 125 in computation mesh 100. Grid lines 185 intersect such that computation mesh 100 includes a plurality of grid cells 190 that define a grid cell area 190a. A plurality of angles 195 (where angle 195 may be referred to as θ) are formed by the intersection of each of ξ-grid lines 185a with inner boundary 165 and outer boundary 170.

In one example, a grid cell provides a model for analyzing a portion of the computation mesh. The grid cells may be used to approximate a property associated with one or more analytical methods. Examples of such methods include, but are not limited to, computational fluid dynamics, finite element analysis, heat transfer modeling, stress/strain computations and any combinations thereof. Despite the complicated mathematical features of a chosen analytical method, such as, computational fluid dynamics, the approximate properties for each of the grid cells can be aggregated to obtain a complete analytical model.

In one example, each value of a computation coordinate ξ and value of a computation coordinate η in a computation space (e.g., computation space 105) may be utilized to determine a P(ξ,η) and Q(ξ,η) for each grid point.

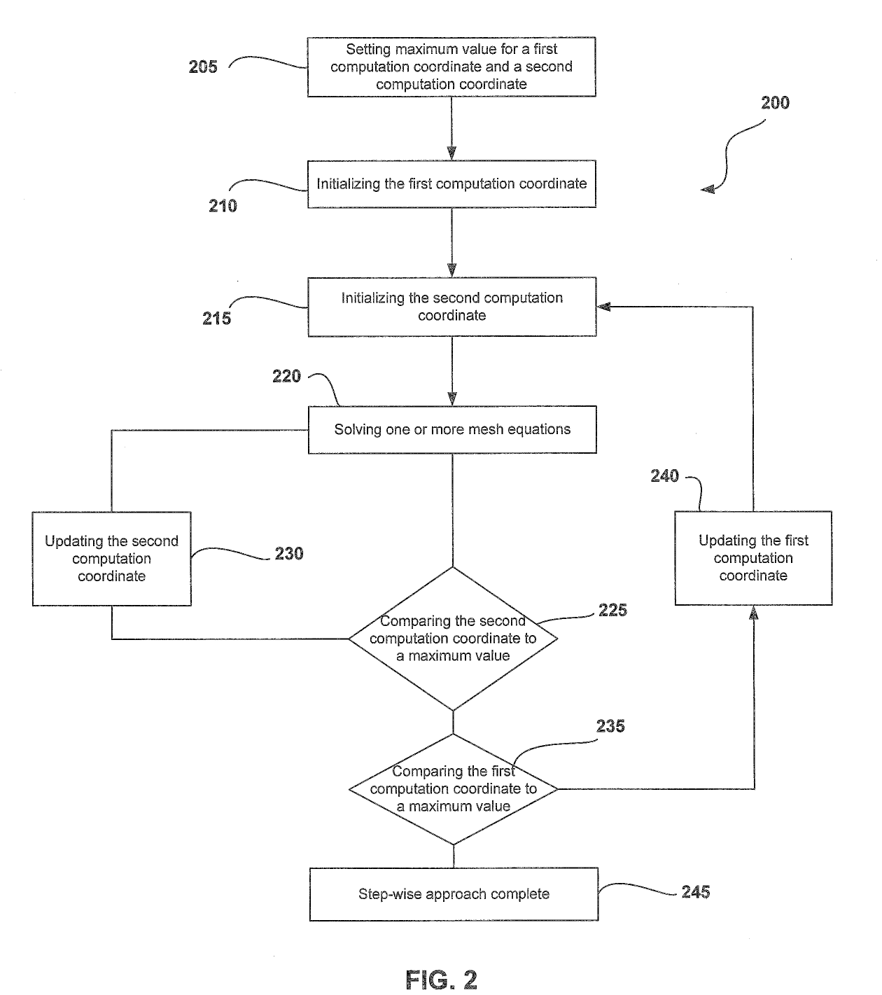

FIG. 2 illustrates one example of a step-wise approach 200 for solving one or more mesh equations, such as one or more mesh equations including an integrated source term and metric coefficients as disclosed herein. At step 205, a maximum value for each of computation coordinate ξ (where the maximum value may be referred to as ξ_{MAX}) and computation coordinate η (where the maximum value may be referred to as η_{MAX}) is set. In one example, the value of ξ_{MAX} and η_{MAX} is the number of grid points along the η-grid lines (N) and the number of grid points along the ξ-grid lines (M), respectively. At step 210 and 215, an initial value of coordinate ξ and η are set. In one example, the initial value of both coordinates ξ and η is 0. In another example, any value may be used as the initial value. In yet another example, an initial value may be based on the number of grid points, the value of M and N, the type of grid to be generated, among others.

At step 220, one or more mesh equations for each of the values for coordinates ξ and η are solved. At step 225, a value of coordinate ξ is compared to the value of ξ_{MAX}. If the value of coordinate ξ is less than the value of ξ_{MAX}, then at step 230, approach 200 includes updating the value of coordinate ξ by an incremental adjustment. An incremental adjustment changes the most recent value of the coordinate ξ by a known amount. In one example, an incremental adjustment is 1. Utilizing this exemplary incremental adjustment, an updated value of coordinate ξ is ξ+1.

When the value of coordinate ξ is equal to the value of ξ_{MAX}, then at step 235, approach 200 includes comparing the value of coordinate η to η_{MAX}. If the value of coordinate η is less than the value of η_{MAX}, then at step 240 approach 200 includes updating the value of coordinate η by an incremental adjustment. An incremental adjustment changes the most recent value of the coordinate η by a known amount. In one example, an incremental adjustment is 1. Utilizing this incremental adjustment, an updated value of coordinate η is η+1.

In exemplary approach 200 this iteration continues until coordinate η is equal to the value of η_{MAX}. At this point in approach 200, the one or more mesh equations have been solved for each value of coordinate ξ and coordinate η. Table 1 illustrates a hypothetical example solution based on the application of a step-wise approach (e.g., step-wise approach 200) to solve one or more mesh equations for a computation mesh (e.g., computation mesh 100 (FIG. 1)). In this example, grid locations for each of grid points 150-165 are determined by hypothetically solving one or more mesh equations for values of source term P(ξ,η) and Q(ξ,η):

TABLE 1

| Point | ξ | η | P(ξ, η) | Q(ξ, η) |
|---|---|---|---|---|
| 150 | 0 | 0 | P^{(x)}1, P^{(y)}1 | Q^{(x)}1, Q^{(y)}1 |
| 151 | 1 | 0 | P^{(x)}2, P^{(y)}2 | Q^{(x)}2, Q^{(y)}2 |
| 152 | 2 | 0 | P^{(x)}3, P^{(y)}3 | Q^{(x)}3, Q^{(y)}3 |
| 153 | 3 | 0 | P^{(x)}4, P^{(y)}4 | Q^{(x)}4, Q^{(y)}4 |
| 154 | 4 | 0 | P^{(x)}5, P^{(y)}5 | Q^{(x)}5, Q^{(y)}5 |
| 155 | 5 | 0 | P^{(x)}6, P^{(y)}6 | Q^{(x)}6, Q^{(y)}6 |
| 156 | 6 | 0 | P^{(x)}7, P^{(y)}7 | Q^{(x)}7, Q^{(y)}7 |
| 157 | 7 | 0 | P^{(x)}8, P^{(y)}8 | Q^{(x)}8, Q^{(y)}8 |
| 158 | 8 | 0 | P^{(x)}9, P^{(y)}9 | Q^{(x)}9, Q^{(y)}9 |
| 159 | 9 | 0 | P^{(x)}10, P^{(y)}10 | Q^{(x)}10, Q^{(y)}10 |
| 160 | 10 | 0 | P^{(x)}11, P^{(y)}11 | Q^{(x)}11, Q^{(y)}11 |
| 161 | 1 | 1 | P^{(x)}12, P^{(y)}12 | Q^{(x)}12, Q^{(y)}12 |
| 162 | 2 | 2 | P^{(x)}13, P^{(y)}13 | Q^{(x)}13, Q^{(y)}13 |
| 163 | 3 | 3 | P^{(x)}14, P^{(y)}14 | Q^{(x)}14, Q^{(y)}14 |
| 164 | 4 | 4 | P^{(x)}15, P^{(y)}15 | Q^{(x)}15, Q^{(y)}15 |
| 165 | 5 | 5 | P^{(x)}16, P^{(y)}16 | Q^{(x)}16, Q^{(y)}16 |

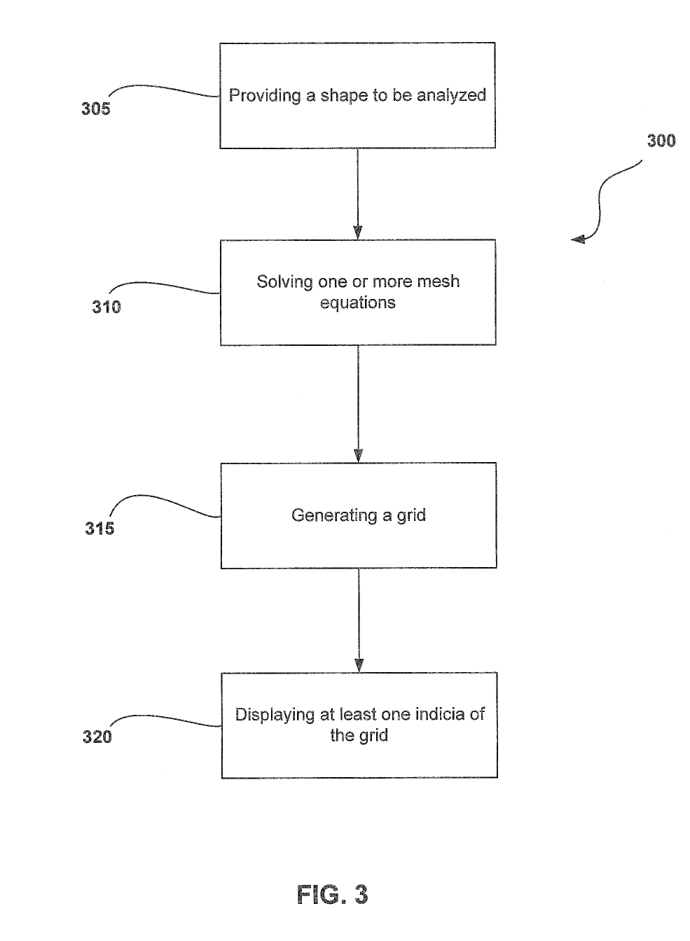

FIG. 3 illustrates one exemplary embodiment of a method 300 that employs one or more mesh equations to generate a computation mesh (e.g., computation mesh 100 (FIG. 1)). Method 300, at stage 305, includes providing information corresponding to a shape (e.g., shape 160 (FIG. 1)) for analysis using one or more analytical tools and/or methods (e.g., computational fluid dynamics, finite element analysis, heat transfer analysis, and vibrational analysis). Information corresponding to a shape may be provided in a variety of ways. In one example, information corresponding to a shape is provided by a user. In another example, information corresponding to a shape is provided by an electronic means for creating, designing, and/or rendering such information (e.g., a computer aided design software application used in conjunction with a system and/or method according to the disclosure herein for generating a computational mesh).

Information corresponding to a shape may include a variety of data that may be used in conjunction with a system and/or method of generating a computational mesh according to the current disclosure. Examples of information that may be included in information corresponding to a shape include, but are not limited to, one or more data representations of a plurality of points defining a boundary of a shape, data representing a function defining a boundary of a shape, one or more data representations of a plurality of points defining an outer boundary for a computation mesh for a shape, data representing a function defining an outer boundary for a computation mesh for a shape, a number of grid points along the η-grid lines (N), and any combinations thereof.

Information corresponding to a shape may represent a variety of shapes, including but not limited to, a two-dimensional shape (e.g., a segment of a three-dimensional shape), a three-dimensional shape, and any combinations thereof. In one example, a three-dimensional shape may be divided into a plurality of two-dimensional shape segments (e.g., slices), each of which may be subjected to an analysis requiring a computation mesh. One or more mesh equations as described herein may be utilized to generate each computation mesh.

In addition to the provision of information corresponding to a shape, other information may also be provided. In one embodiment, information corresponding to a mesh parameter and/or a value of a mesh parameter may be provided. Examples of a mesh parameter include, but are not limited to, a number of grid points along the ξ-grid lines (M), a number of grid points along the η-grid lines (N), and any combinations thereof. In one example, a value for M is provided. In another example, a value for N is provided. In yet another example, a value for M and a value for N is provided. It is contemplated that in one embodiment a user may provide only information corresponding to a shape, a value for M, and a value for N (e.g., separate information corresponding to N, information corresponding to N incorporated into the information corresponding to a shape). In an alternate example, the number of grid points along the η-grid lines (N) are incorporated into one or more portions of the shape, e.g., the defining edge of the shape shown in FIG. 1. In another example, the number of grid points along the η-grid lines (N) are assigned according to a user preference. In still another example, both the number of grid points along the η-grid lines (N) and the number of grid points along the ξ-grid lines (M) are implemented at a time relative to providing the shape at stage 305.

In one example, it is also contemplated that the mesh parameters can be defined subsequent to the execution of method 300. In one example, a user can input mesh parameters based on one or more prompts from a computer-implementation of method 300 before providing a shape to be analyzed. It is further contemplated that the mesh parameters can be defined contemporaneous with the execution of method 300. In one example, a user can input mesh parameters based on one or more prompts from a computer-implementation of method 300 before while providing a shape to be analyzed. It is still further contemplated that the mesh parameters can be defined after the execution of method 300. In one example, a user can input different mesh parameters based on one or more prompts from a computer-implementation of method 300.

At stage 310, method 300 includes solving the one or more mesh equations. In one example, one or more mesh equations depend on an outer boundary distance parameter determined by a function of an inner boundary distance parameter. In the present example, solving the one or more mesh equations determines the physical coordinates of grid locations for the plurality of grid points in a computation mesh.

At stage 315, method 300 includes generating a computation mesh as a function of the grid locations. In one example, method 300 uses the physical coordinates of the grid locations to construct a computational mesh based on a position of each of the plurality of grid points proximate the shape to be analyzed. In another example, method 300 uses the physical coordinates of the grid locations to construct a computational mesh based on a position of each of the plurality of grid points with respect to a set of axes. In still another example, method 300 positions each of the plurality of grid points and connects the grid points with one or more ξ-grid lines and one or more η-grid lines.

At stage 320, method 300 includes outputting one or more indicia that represent the computation mesh, or a portion thereof. An indicia is a representative portion of the computation mesh. Examples of an indicia include, but are not limited to, a graph, a plot, a point, a set of axes, an displayable image, and any combination thereof. In one example, an indicia is a full view of the computation mesh, such as those views illustrated in the Experimental Examples below. In another example, an indicia is a portion of the computation mesh having analytical significance to the user. In another example, an indicia is a computation mesh, or portion of a computation mesh, selected by a user for outputting.

The indicia can be output to a variety of different places. In one example, outputting an indicia representing the computational mesh can occur on a computer-related peripheral device. A variety of peripheral output devices are discussed below with respect to an exemplary machine environment for implementation of any one or more of the aspects and/or embodiments disclosed herein. In one example, a computer-related peripheral is a display device (e.g., a computer monitor). In another example, the computer-related peripheral is a PDA. In still another example, outputting an indicia representing a computational mesh can occur via a network connection so as to cause the computation mesh to output in a different computer-related application, e.g., a computational fluid dynamics application. Although not illustrated, it is contemplated that outputting the indicia can occur simultaneously with the generation of the computation mesh discussed in step 315. It is further contemplated that outputting the indicia can occur after the computation mesh is generated in stage 315.

In alternative exemplary implementation of a method of FIG. 3, a method may include a repetitive mathematical operation that determines the physical coordinates of the grid locations utilizing one or more mesh equations according to a repetitive calculation. A repetitive calculation involves successively updating the physical coordinates for each grid location of the grid points in the grid of a computation mesh based on the solution of the one or more mesh equations.

In one example, a terminating criteria (e.g., an error threshold) may be provided for to determine the completion of a repetitive calculation. In one example a terminating criteria is a variable, or other value, which indicates when the proper (e.g., desired) physical coordinates for each grid location are determined. Examples of a terminating criteria include, without limitation, an error value, a maximum number of repetitions, a convergence criteria, and any combinations thereof. In one example, if the terminating criteria is an error value, method 300 continues to calculate the physical coordinates for each grid location until the error value is met. In another example, if the terminating criteria is a maximum number of repetitions, method 300 will continue until the maximum number of iterations is reached.

A variety of repetitive mathematical operations are known in the art. Examples of a repetitive mathematical operation include, but are not limited to, a direct mathematical method, an iterative mathematical method, a domain decomposition method, an approximate factorization method and any combinations thereof. In one embodiment of a Variational system and/or method, an iterative mathematical method is used. An iterative mathematical method is a numerical method used to solve the one or more mesh equations (e.g., Equations 3 and 4) by generating successive approximate solutions to a given equation (or set of equations), such as the one or more mesh equations. Examples of an iterative method include, but are not limited to, successive line over-relaxation (SOR) method, Jacobi method, Gauss-Seidel method, and any combinations thereof. Although discussed as one exemplary implementation below, a more technical discussion of an iterative method, such as an SOR method, and the mathematical techniques associated with the application of such method to elliptic grid generation is available in open literature and engineering text, such as, for example, Computation Fluid Mechanics and Heat Transfer, Hemisphere Publishing Company (1994), incorporated herein by reference in its entirety.

In one example, an iterative mathematical method generates a final solution set of physical coordinates from an initial approximation for the solution set of physical coordinates. A solution set includes a plurality of physical coordinates that can satisfy one or more mesh equations. Examples of a solution set include, but are not limited to, a matrix, a list, a series of equations and any combinations thereof. In one example, a solution set is a coordinate matrix that includes physical coordinates for grid locations of the plurality of grid points in a computation mesh.

The size of a coordinate matrix can be defined in a number of ways. In one example, the size is equal to the number of grid points along the grid lines (M). In another example, the size is equal to the number of grid points. In still another example, the size is equal to the number of grid points along the η-grid lines (N). When used in conjunction with an iterative mathematical method, the physical coordinates within a coordinate matrix may be repeated changed. In one example, to maintain continuity throughout a calculation, each of the physical coordinates may have a position within a coordinate matrix.

In one example, these positions may be defined by the size of the coordinate matrix. A position within a one-dimensional matrix, for instance, may be defined by a single variable based on the size of the matrix. In another example, a position within a two-dimensional matrix may be defined by two variables based on the size of the matrix. These variables may be integers, such as [1, 2, 3 . . . ]. Although for purposes of clarifying the discussion of the positions within a coordinate matrix in the following examples may be referred to by variables (i,j), it is contemplated that the choice of any variables for defining a coordinate matrix or other solution set is within the scope and meaning of this disclosure.

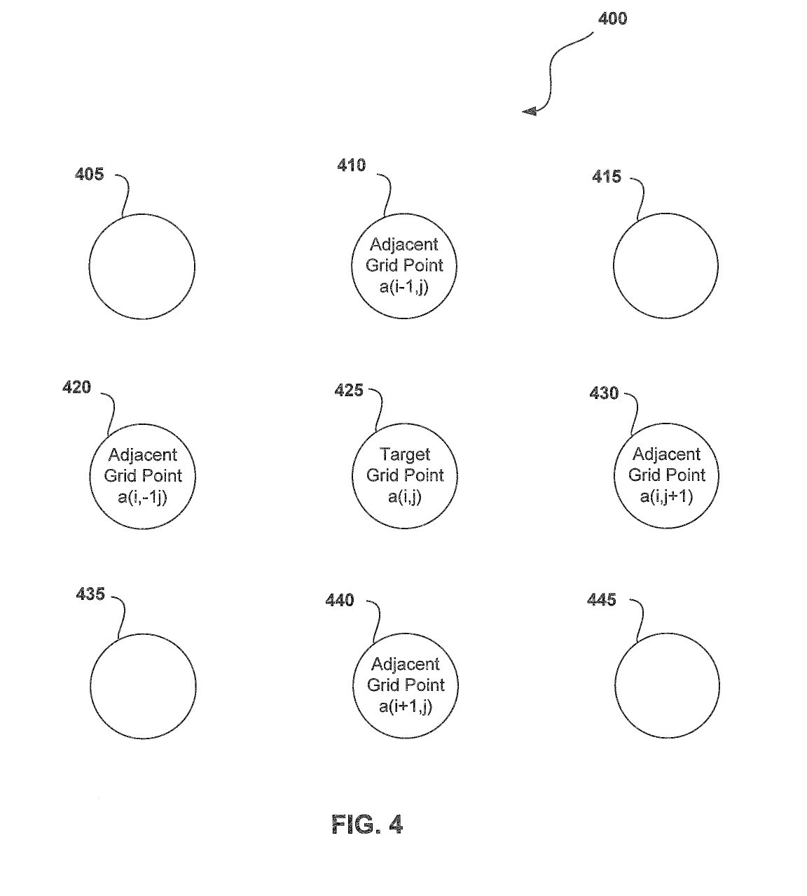

FIG. 4 illustrates one example 400 of a series of grid points within a computation mesh. In this example, grid points 400 are generated using an iterative method to solve one or more mesh equations (e.g., Equations 3 and 4). Grid points 400 include grid points 405-445. Each of grid points 405-445 includes a grid location 450 having physical coordinates (x,y) 455. In one example, an iterative mathematical method determines physical coordinates (x,y) for a target grid point 425 as a function of the physical coordinates (x,y) of the grid points adjacent the target grid point. A target grid point is a grid point (e.g., grid point 425) for which the physical coordinates (x,y) are determined. Although only a portion of grid points 400 is provided, it is contemplated that the following discussion about the application of an iterative mathematical method to determine the physical coordinates (x,y) of a target grid point can be applied to any number of grid points of a grid of a computation mesh.

The physical coordinates (x,y) for target grid point 425 may be determined as a function of the physical coordinates (x,y) of adjacent grid points. As illustrated in FIG. 4, the adjacent grid points include grid points 410, 420, 430 and 440. Each of these grid points have a corresponding physical coordinate (x,y) in a solution set, e.g., a coordinate matrix having positions (i,j). To determine which physical coordinates (x,y) are adjacent the target grid point, an exemplary iterative method utilizes the position of each physical coordinate (x,y) relative to the position within the coordinate matrix of the physical coordinate (x,y) for target grid point 425. It follows that the position of a physical coordinates (x,y) in the coordinate matrix for each adjacent grid point relative to the position of the physical coordinates (x,y) of the target grid point 425 is: grid point 410 (i−1, j); grid point 420 are (i, j−1); grid point 430 are (i, j+1); and grid point 440 are (i+1, j).

As mentioned above, in this example, an iterative mathematical method may manipulate the initial approximation for the solution set of physical coordinates. In one example, an iterative mathematical method generates successive solution sets of physical coordinates (x,y) by repeatedly solving the same equation (or set of equations). Each of these successive solution sets include physical coordinates (x,y) that vary from the previous solution set. As described in more detail below, variation of physical coordinates from one solution set to another depends on solving the or more mesh equations (e.g., Equations 3 and 4).

In one example of grid points 400, an iterative mathematical method substitutes one or more of the physical coordinates into the one or more mesh equations (e.g., Equations 3 and 4). By solving the one or more mesh equations, the iterative mathematical method determines if the physical coordinates satisfy the one or more mesh equations. In one example, an iterative mathematical method utilizes the physical coordinates (x,y) so as to solve the left side and the right side in Equations 3 and 4. With reference to the step-wise approach discussed above and illustrated in FIG. 2, an iterative method may utilize the physical coordinates for each of the grid points in a computation mesh by successively increasing the values of one or more variables that define the solution set, e.g., a coordinate matrix.

It should be noted that a variety of methods and variations of aspects of methods for generating a computation mesh according to the above described aspects and embodiments will be clear to one or ordinary skill. FIGS. 29 and 30A to 30C illustrate one exemplary embodiment of an iterative method of solving one or more mesh equations.

It is to be noted that the aspects and embodiments described herein may be conveniently implemented using one or more machines (e.g., a computing device) programmed according to the teachings of the present specification, as will be apparent to those of ordinary skill in the computer art. For example, various aspects of a method for a method of generating a computation mesh as described herein, may be implemented as machine-executable instructions (i.e., software coding), such as program modules executed by one or more machines. Typically a program module may include routines, programs, objects, components, data structures, etc. that perform specific tasks. Appropriate machine-executable instructions can readily be prepared by skilled programmers based on the teachings of the present disclosure, as will be apparent to those of ordinary skill in the software art.

Such software may be a computer program product that employs a machine-readable medium. Example computer programs include, but are not limited to, an operating system, a browser application, a micro-browser application, a proxy application, a business application, a server application, an email application, an online service application, an interactive television client application, an ISP client application, a gateway application, a tunneling application, and any combinations thereof. A machine-readable medium may be any medium that is capable of storing and/or encoding a sequence of instructions for execution by a machine (e.g., a computing device) and that causes the machine to perform any one of the methodologies and/or embodiments described herein. Examples of a machine-readable medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as a collection of physically separate media, such as, for example, a collection of compact disks or one or more hard disk drives in combination with a computer memory.

Examples of a computing device include, but are not limited to, a general purpose computer; a special purpose computer; a computer workstation; a terminal computer; a notebook/laptop computer; a server computer; a handheld device (e.g., tablet computer, a personal digital assistant “PDA”, a mobile telephone, etc.); a web appliance; a network router; a network switch; a network bridge; a set-top box “STB;” video tape recorder “VTR;” a digital video recorder “DVR;” a digital video disc “DVD” device (e.g., a DVD recorder, a DVD reader); any machine, component, tool, equipment capable of executing a sequence of instructions that specify an action to be taken by that machine, and any combinations thereof. In one example, a computing device may include and/or be included in, a kiosk. In another example, a computing device includes a mobile device. In yet another example, a computing device includes a device configured for display of video and/or audio content accessed over a network.

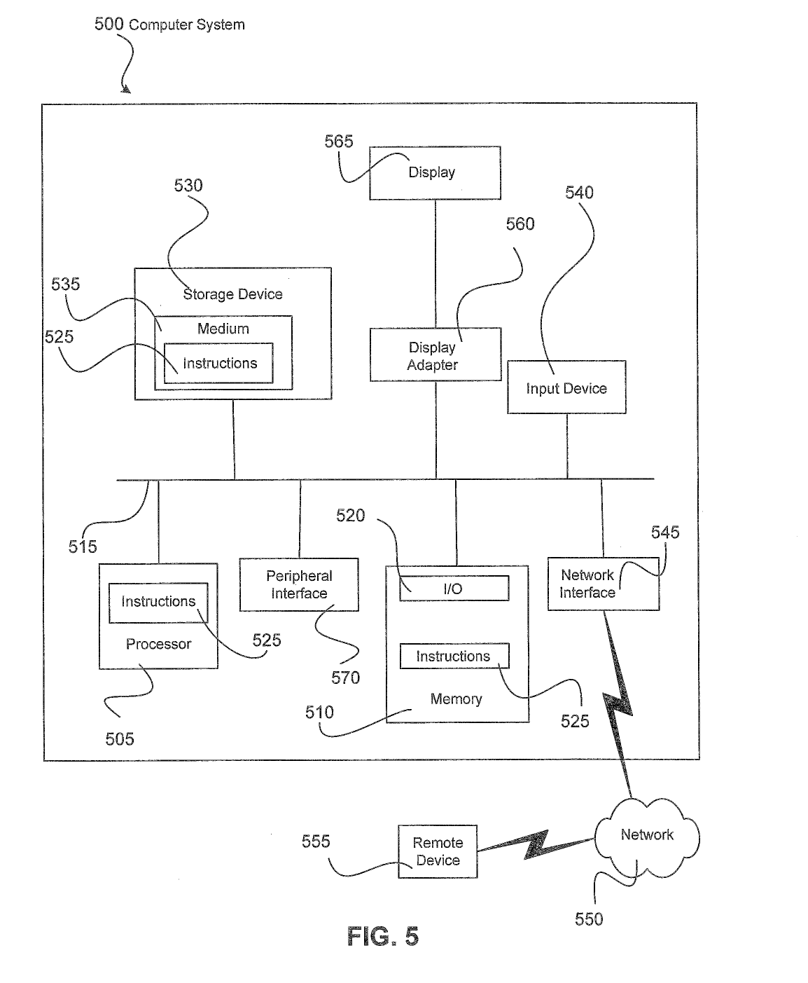

FIG. 5 shows a diagrammatic representation of one embodiment of a machine in the exemplary form of a computer system 500 within which a set of instructions for causing the computing device to perform any one or more of the aspects and/or methodologies of the present disclosure may be executed. It should be noted that although computer system 500 itself and its components may be shown as singular entities, each component and computer system 500 may include any number of components configured to perform a certain functionality. For example, multiple computer systems 500 may combine to perform any one or more of the aspects and/or methodologies of the present disclosure. Additionally any one aspect and/or methodology of the present disclosure may be dispersed across any number of computer system 500 or across any number of computer system components.

Computer system 500 includes a processor 505 and a memory 510 that communicate with each other, and with other components, via a bus 515. Bus 515 may include any of several types of bus structures including, but not limited to, a memory bus, a memory controller, a peripheral bus, a local bus, and any combinations thereof, using any of a variety of bus architectures.

Memory 510 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 520 (BIOS), including basic routines that help to transfer information between elements within computer system 500, such as during start-up, may be stored in memory 510. Memory 510 may also include (e.g., stored on one or more machine-readable media) instructions (e.g., software) 525 embodying any one or more of the aspects and/or methodologies of the present disclosure. In another example, memory 510 may further include any number of program modules including, but not limited to, an operating system, one or more application programs, other program modules, program data, and any combinations thereof.

Computer system 500 may also include a storage device 530. Examples of a storage device (e.g., storage device 530) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 530 may be connected to bus 515 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 530 may be removably interfaced with computer system 500 (e.g., via an external port connector (not shown)). Particularly, storage device 530 and an associated machine-readable medium 535 may provide nonvolatile and/or volatile storage of machine-readable instructions, data structures, program modules, and/or other data for computer system 500. In one example, software 525 may reside, completely or partially, within machine-readable medium 535. In another example, software 525 may reside, completely or partially, within processor 505.

Computer system 500 may also include an input device 540. In one example, a user of computer system 500 may enter commands and/or other information into computer system 500 via input device 540. For example, a user may utilize a computing device with an input device, such as input device 540 to enter information corresponding to a shape and/or one or more mesh parameters. Examples of an input device 540 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 540 may be interfaced to bus 515 via any of a variety of interfaces (not shown) including, but not limited to, a serial interface, a parallel interface, a game port, a USB interface, a FIREWIRE interface, a direct interface to bus 515, and any combinations thereof.

A user may also input commands and/or other information to computer system 500 via storage device 530 (e.g., a removable disk drive, a flash drive, etc.) and/or a network interface device 545. A network interface device, such as network interface device 545 may be utilized for connecting computer system 500 to one or more of a variety of networks, such as network 550, and one or more remote computing devices 555 connected thereto. Examples of a network interface device include, but are not limited to, a network interface card, a modem, and any combination thereof. A network may include one or more elements configured to communicate data (e.g., direct data, deliver data). Examples of a network element include, but are not limited to, a router, a server, a switch, a proxy server, an adapter, an intermediate node, a wired data pathway, a wireless data pathway, and any combinations thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 550, may employ a wired and/or a wireless mode of communication. Various communication protocols (e.g., HTTP, WAP, TCP/IP) and/or encripytion protocols (e.g., UDP) may be utilized in connecting and/or for communication over a network, such as network 550. In general, any network topology may be used. Information (e.g., data, software 525, etc.) may be communicated to and/or from computer system 500 via network interface device 545. In yet another example, storage device 530 may be connected to bus 515 via network interface 545. In still another example, input device 540 may be connected to bus 515 via network interface 545.

Computer system 500 may further include a video display adapter 560 for communicating a displayable image to a display device, such as display device 565. For example, video display adapter 560 may be utilized to display an interface for accessing one or more content items over a network to display device 565. Examples of a display device include, but are not limited to, a liquid crystal display (LCD), a cathode ray tube (CRT), a plasma display, and any combinations thereof. In addition to a display device, a computer system 500 may include one or more other peripheral output devices including, but not limited to, an audio speaker, a printer, and any combinations thereof. Such peripheral output devices may be connected to bus 515 via a peripheral interface 570. Examples of a peripheral interface include, but are not limited to, a serial port, a USB connection, a FIREWIRE connection, a parallel connection, and any combinations thereof.

A digitizer (not shown) and an accompanying pen/stylus, if needed, may be included in order to digitally capture freehand input. A pen digitizer may be separately configured or coextensive with a display area of display device 565. Accordingly, a digitizer may be integrated with display device 565, or may exist as a separate device overlaying or otherwise appended to display device 565.

### EXPERIMENTAL EXAMPLES

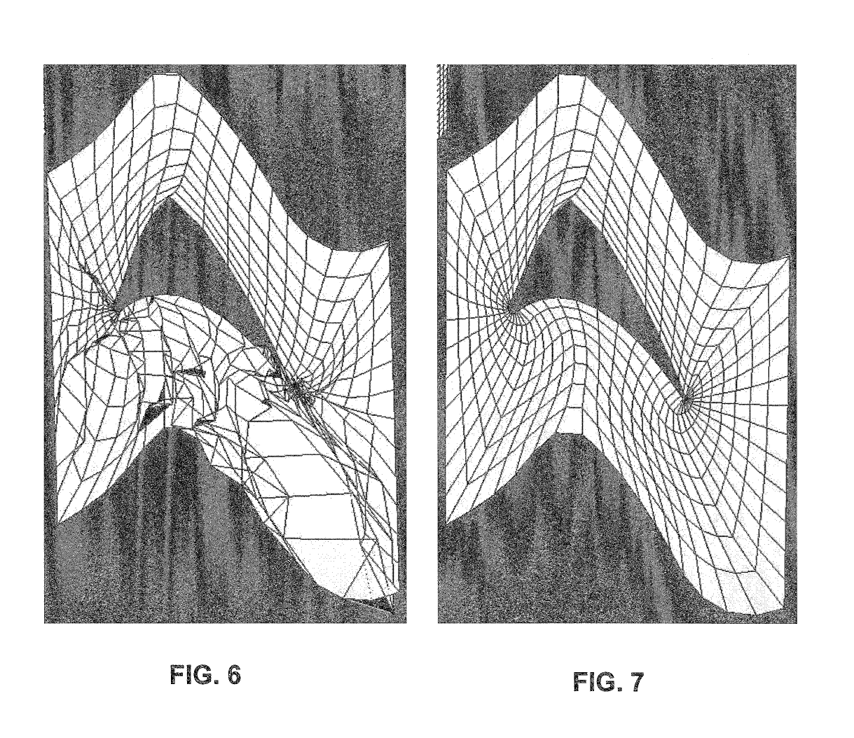

FIGS. 6-7 illustrate examples 600, 700 of computation meshes generated for a turbine blade. It is noted that computation mesh 600 includes grid points determined utilizing one or more mesh equations that did not include a cell shape modifying component to the source terms or geometric coefficients. By way of comparison, computation mesh 700 was generated with one or more mesh equations having an integrated source terms and geometric coefficients including a grid clustering component and one or more cell shape modifying components that include an orthagonality error functional and an area error functional. Although computation mesh 600 and 700 had identical mesh parameters (M=9, N=44), it is further noted that computation mesh 700 includes a grid having substantially better spaced grid points and having grid cells with substantially uniform cell areas.

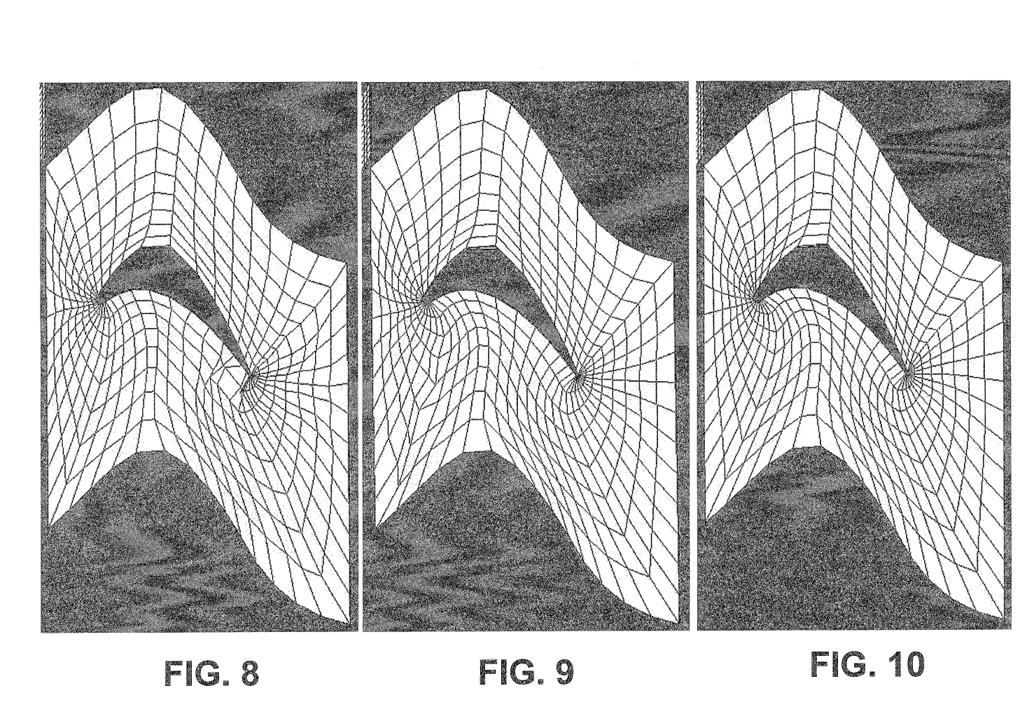

FIGS. 8-10 illustrate examples 800, 900, 1000 of computation meshes generated for another turbine blade. As with FIG. 7 above, it is noted that computation mesh 800 includes grid points determined utilizing one or more mesh equations that did not include an integrated cell shape modifying component. Computation meshes 900, 1000 were generated using one or more mesh equations having an integrated cell shape modifying component and grid clustering component. As illustrated by computational mesh 900, a noticeable improvement to the grid of computation mesh 800 was generated with one or more mesh equations having integrated source terms and geometric coefficients including a grid clustering component and one or more cell shape modifying components that include an area error functional. Computational mesh 1000 indicates that additional improvements are possible by using a cell shape modifying component that includes both an area error functional and an orthagonality error functional. Computation meshes 800, 900, 1000 had identical input mesh parameters (M=9, N=44). It is further noted that computation mesh 900 and 1000 include a grid having substantially better spaced grid points and having grid cells with substantially uniform cell areas when compared to the grid of computation mesh 800.

FIGS. 11-14 illustrate examples 1100, 1200, 1300, 1400 of computation meshes generated for another turbine blade. It is noted that computation meshes 1100 and 1300 include grid points determined utilizing one or more mesh equations that did not include integrated source terms and geometric coefficients as disclosed herein. Computation mesh 1200 and 1400 include grid points determined utilizing one or more mesh equations that included integrated source terms and geometric coefficients including a grid clustering component and one or more cell shape modifying components having an area error functional and an orthagonality error functional. By way of comparison, it is noted that the use of integrated source terms and geometric coefficients improves the overall spacing and uniformity of the grid cells and grid points. By focusing on computation meshes 1300 and 1400, it is noted that the grid points determined by a mesh equation as disclosed herein include grid lines that are substantially more uniform.

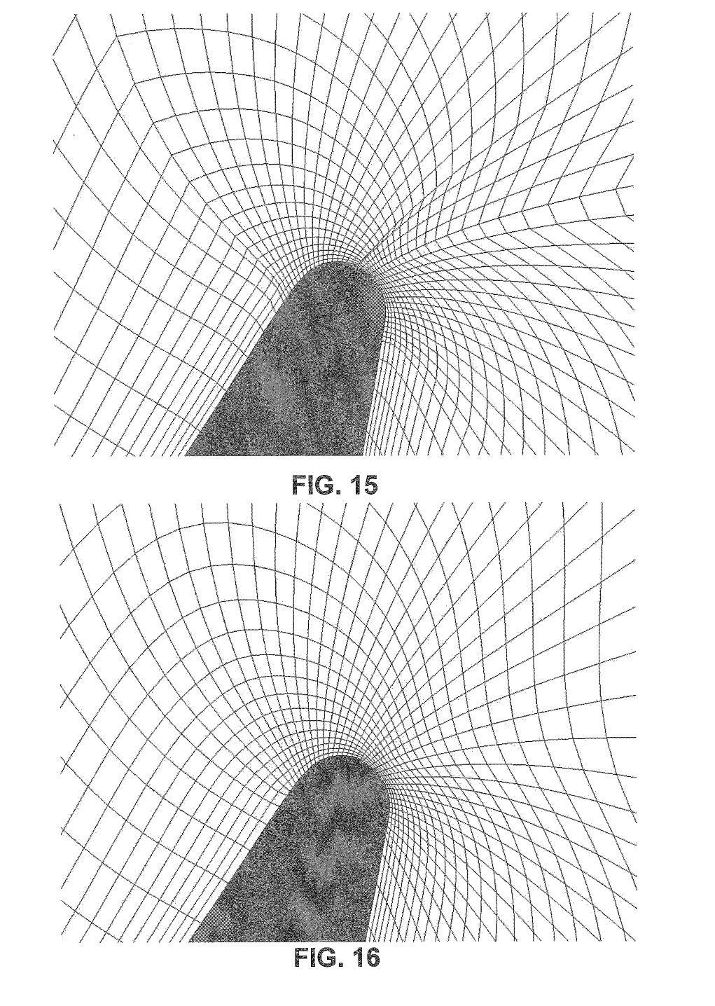

FIGS. 15-16 illustrate examples 1500, 1600 of computation meshes generated for the trailing edge of another turbine blade. As with the examples provided above, computation mesh 1200 includes grid points determined utilizing one or more mesh equations that did not include integrated source terms and geometric coefficients as disclosed herein. By comparison, computation mesh 1600 include grid points determined using one or more mesh equations that included integrated source terms and geometric coefficients including a grid clustering component and one or more cell shape modifying components having a smoothness error functional. By using the smoothness error functional, it is noted that the sharp corners formed along the trailing edge of computation mesh 1500 are substantially eliminated and replaced by a smooth section having uniformly spaced grid points.

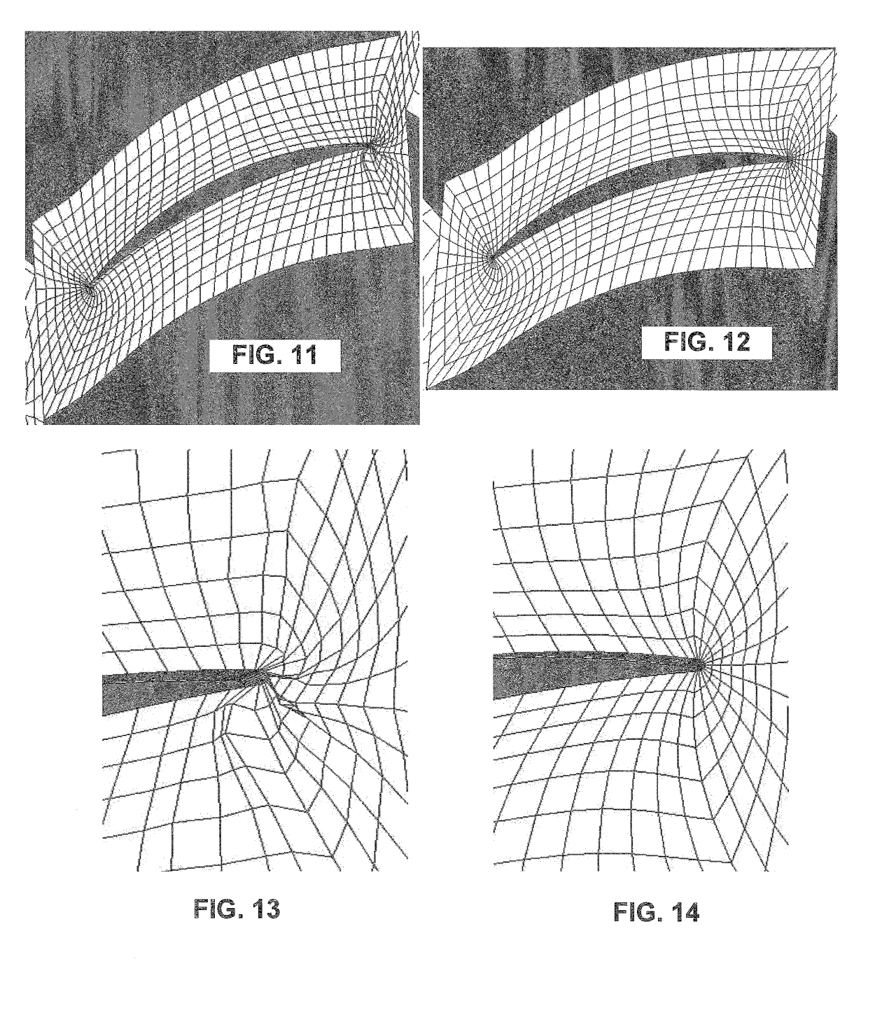

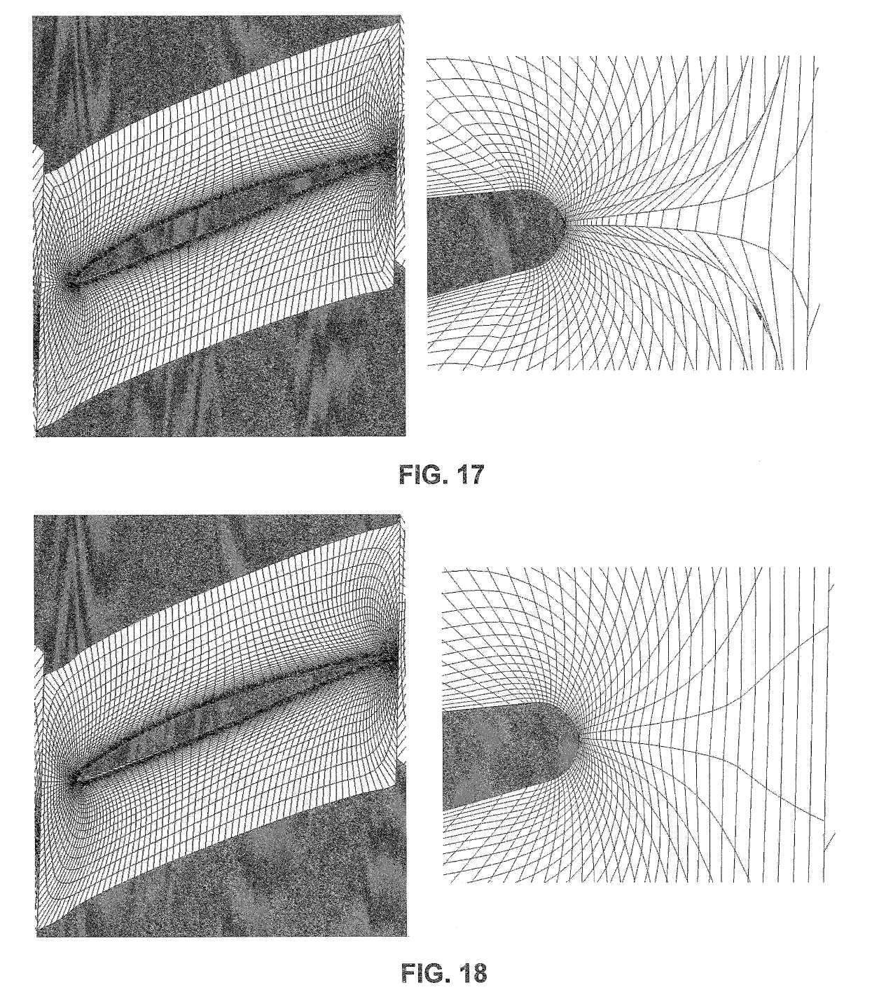

FIGS. 17-18 illustrate examples 1700, 1800 of computation meshes for the trailing edge of a turbine blade. Like FIG. 13 above, it is noted that computation mesh 1700 includes grid points determined utilizing one or more mesh equations that did not include integrated source terms and geometric coefficients as disclosed herein. As illustrated by computational mesh 1800, a noticeable improvement to the grid of computation mesh 1700 is made by applying were generated using one or more mesh equations having a grid clustering component integrated with a cell shape modifying component that includes an area error functional. By way of comparison, the sharp corners formed along the trailing edge of computation mesh 1700 are substantially eliminated and replaced by a smooth section having uniformly spaced grid points.

### EXAMPLE ITERATIVE METHODS

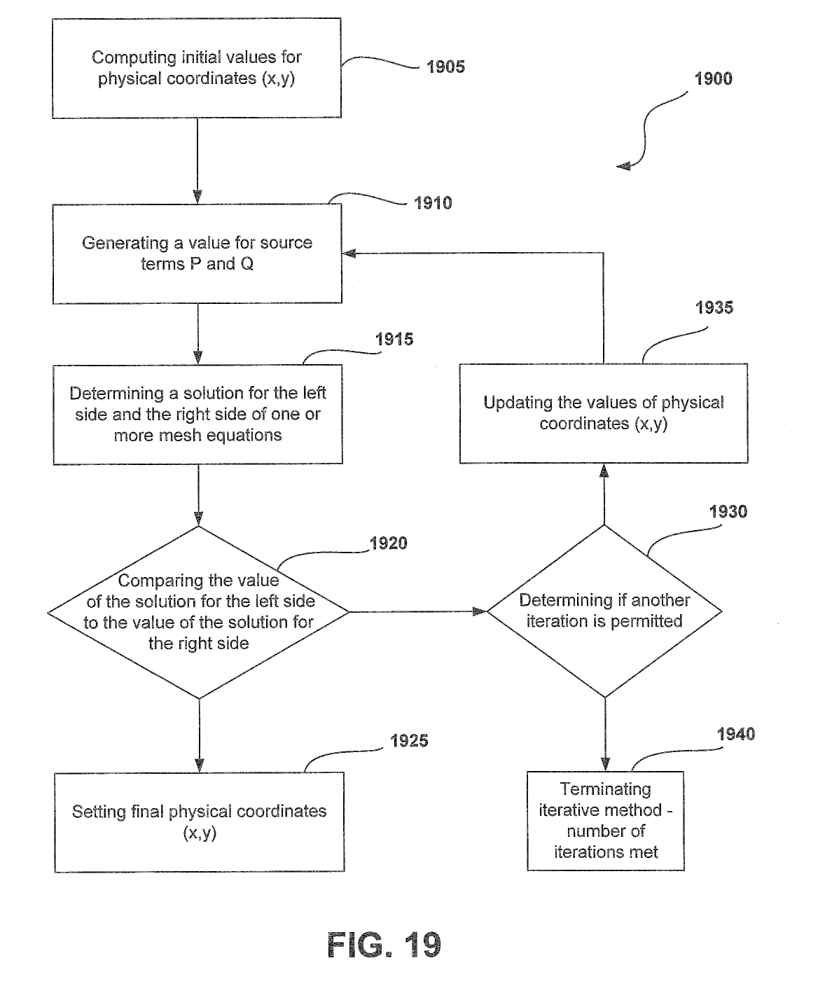

FIG. 19 illustrates one implementation of an iterative method 1900 that may be used to solve one or more mesh equations. Iterative method 1900, at stage 1905, includes computing initial values for physical coordinates (x,y) for each of the grid points in the computation mesh. An initial value is a mathematical estimate that is used to solve one or more mesh equations. Examples of an initial value include, but are not limited to, a guess, an approximation, a random selection, a mathematical solution and any combination thereof. In one example, the initial values for each of the physical coordinates (x,y) are determined using a mathematical technique. Examples of such techniques include, but are not limited to, a random selection technique, an interpolation technique, a curve-fitting method and any combinations thereof. Although the remainder of this disclosure will discuss embodiments of a first-point distance parameter system and method in connection with an interpolation technique, it is contemplated that these embodiments can also employ any of the other techniques for selecting and/or determining initial values of physical coordinates (x,y).

There are a variety of interpolation techniques that are known in the art. In general, an interpolation technique is a method of generating values for a variable from a discrete set of known values for similar variables. Examples of interpolation techniques include, but are not limited to, vertical interpolation, horizontal interpolation, tensor product interpolation, transfinite interpolation, among others. In one example, an iterative mathematical method uses a transfinite interpolation technique to determine the initial values for each of the physical coordinates (x,y).

A transfinite interpolation technique determines the initial values of physical coordinates for the remaining grid points of the computation mesh from a discrete set of known physical coordinates (x,y). In one implementation, a discrete set of known physical coordinates (x,y) includes one or more grid points located proximate an inner and an outer boundary. In one example, a discrete set includes physical coordinates (x,y) determined using an inner boundary distance parameters. In another example, a discrete set includes physical coordinates (x,y) determined using an outer boundary parameter D_{M}.

The physical coordinates (x,y) of the remaining grid points of a computation mesh can be computed by applying the generally recognized principles of interpolation techniques. Accordingly, although broadly defined, a more technical discussion of an interpolation technique method, such as an transfinite interpolation technique, and the mathematical techniques associated with the application of such method to elliptic grid generation is available in open literature and engineering text, such as, for example, Computation Fluid Mechanics and Heat Transfer, Hemisphere Publishing Company (1994), incorporated herein by reference in its entirety.

At step 1910, iterative method 1900 includes generating a value for source terms P and Q using the initial values of physical coordinates (x,y) for the grid points. In one example, a value for the first order derivates x_{ξ}, x_{η}, y_{ξ} and y_{η} and second-order derivates x_{ξξ}, x_{ηη}, y_{ξξ}, y_{ηη}, x_{ξη, y}_{ξη} is determined as a function of the initial values of physical coordinates (x,y). Sources p, q, r and s are determined using these values. Based on the discussion above, it follows that values for sources p, q, r and s are used to generate values of sources P and Q.

At step 1915, iterative method 1900 includes determining a solution for the left side and a solution for the right side of one or more mesh equations (e.g., Equations 3 and 4). For purposes of simplifying the discussion, the mesh equations can be re-written as:

H₁=Z₁ Equation (52)

H₂=Z₂ Equation (53)

where H₁ and H₂ are the left side of the equations and Z₁ and Z₂ are the right side of the equations. The right side of the equationmay have a known solution (e.g., zero). On the contrary, the solution for the left side of the equation (e.g., H₁ and H₂) are not known. In one implementation, H₁=g₂₂x_{ξξ}+g₁₁x_{ηη}−2g₁₂x_{ξη}+J²(Px_{ξ}+Qx_{η}) and H₂=g₂₂y_{ξξ}+g₁₁y_{ηη}−2g₁₂y_{ξη}+J² (Py_{ξ}+Qy_{η}), the components of which are described in detail above. A value for H₁ and H₂ can be determined by substituting the values of the first-order derivates x_{ξ}, x_{η}, y_{ξ} and y_{η}, the second-order derivates x_{ξξ}, x_{ηη}, y_{ξξ}, y_{ηη}, x_{ξη}, y_{ξη} and the source terms P and Q determined above.

A feature of an iterative method is the ability to generate values for physical coordinates (x,y) that result in the value of the left side being equal to the value of the right side of the one or more mesh equations. At step 1920, iterative method 1900 includes comparing the value of the left side to the value of the right side of the one or more mesh equations (e.g., Equations 3 and 4). If the value of the left side (e.g., H₁, H₂) equals the value of the right side (e.g., Z₁, Z₂), then at stage 1925, method 1900 includes setting the values for the final physical coordinates (x,y). In the present example, the initial values of physical coordinates (x,y) for the grid points determined in stage 1905 are the final physical coordinates (x,y). The final physical coordinates (x,y) satisfy the one or more mesh equations (e.g., Equations 3 and 4) and can be used to describe the point locations for the grid points of the computation mesh.

If the value of the left side (e.g., H₁, H₂) does not equal the value of the right side (e.g., Z₁, Z₂), then at stage 1930, iterative method 1900 includes determining if another iteration is required. It is typical that the left side and the right side of mesh equations similar to the one or more mesh equations of the present disclosure to never be equal. In order to avoid the iterative method continuing for excessive iterations, one or more terminating criteria that determine whether additional iterations are necessary may be used.

In one example, a terminating criteria is an error value that measures the difference between the value of the physical coordinates (x,y) during the present iteration and the value of the physical coordinates (x,y) during the previous iterations. In general terms and for purposes of simplifying the discussion, an error value can be written as:

ErrorX=Xⁿ−Xⁿ⁻¹ Equation (54)

ErrorY=Yⁿ−Yₙ₋₁ Equation (55)

where ErrorX and ErrorY are error values; Xⁿ and Yⁿ are the value of physical coordinates (x,y) during the present iteration stored in a coordinate matrix; and Xⁿ⁻¹ and Yⁿ⁻¹ are the value of physical coordinates (x,y) during the previous iteration stored in a coordinate matrix. In one example, a first-point distance parameter system and method may include a single error value, such that ErrorX=ErrorY=Error Value.

In operation, if iterative method 1900 determines that the values of ErrorX and ErrorY are both less than a terminating criteria, then the final value of the physical coordinates (x,y) is the value of the physical coordinates (x,y) during the present iteration (e.g., X(i,j) and Y(i,j)). If on the other hand, iterative method 1900 determines that the values of ErrorX or ErrorY or both are not less than a terminating criteria, then at stage 1935, iterative method 1900 includes updating the values of physical coordinates (x,y). Iterative method 1900 continues with another iteration where the values of physical coordinates (x,y) that are stored in the coordinate matrix are modified. In one example, the values of the physical coordinates (x,y) are increased by the value of ErrorX and ErrorY. In another example, the value of the physical coordinates (x,y) are decreased by the value of ErrorX and ErrorY. In still another example, the value of the physical coordinates (x,y) are modified by a percentage of the value of ErrorX and ErrorY.

As illustrated in FIG. 19, the modified values of the physical coordinates (x,y) are used to generate new values for source terms P and Q, first-order derivates x_{ξ}, x_{η}, y_{ξ} and y_{η} and second-order derivates x_{ξξ}, x_{ηη}, y_{ξξ}, y_{ηη}, x_{ξη}, y_{ξη}. These values are used to solve the one or more mesh equations as described above. Alternatively, at stage 1940, method 1900 includes terminating the iterative method when the number of iterations is met. An iterative method may continue until a value for the physical coordinates (x,y) is found so as to meet the terminating criteria. In an alternative example, a first-point distance parameter system and method may include a terminating criteria that limits the number of iterations for any given set of input parameters. In the present example, by limiting the number of iterations, the iterative method will only run up until a fixed number of values of physical coordinates (x,y) are determined.

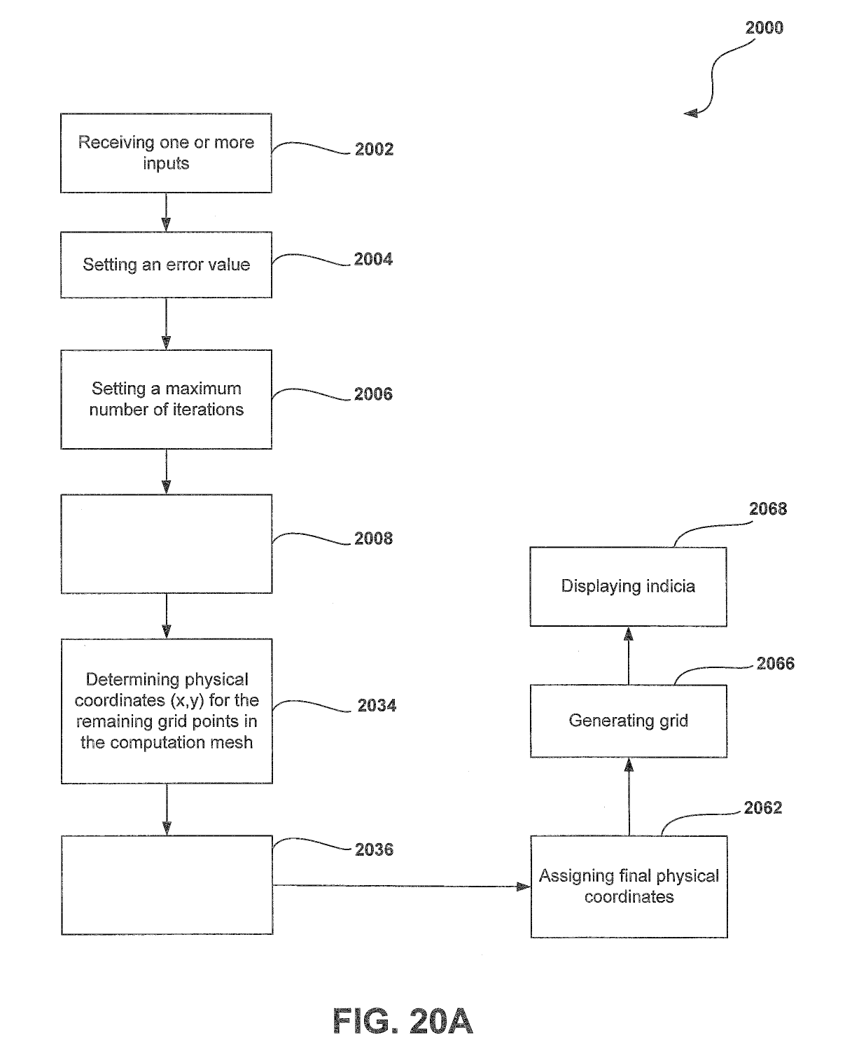

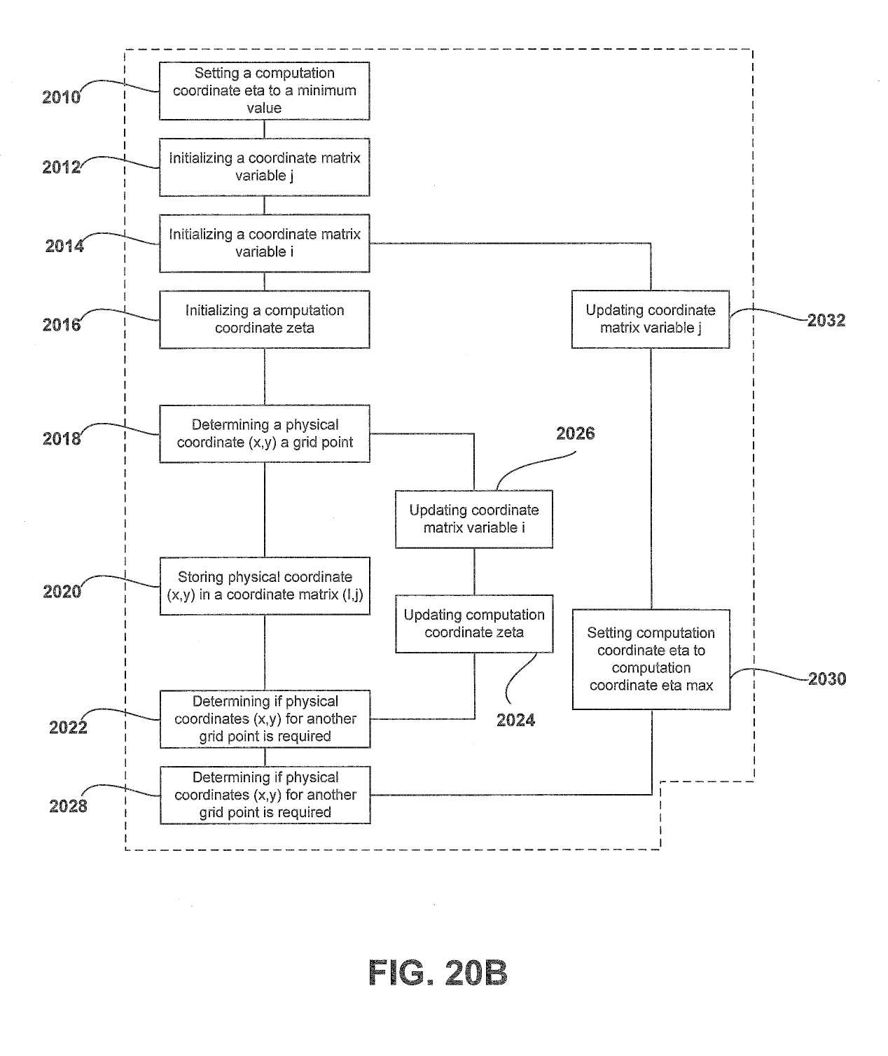

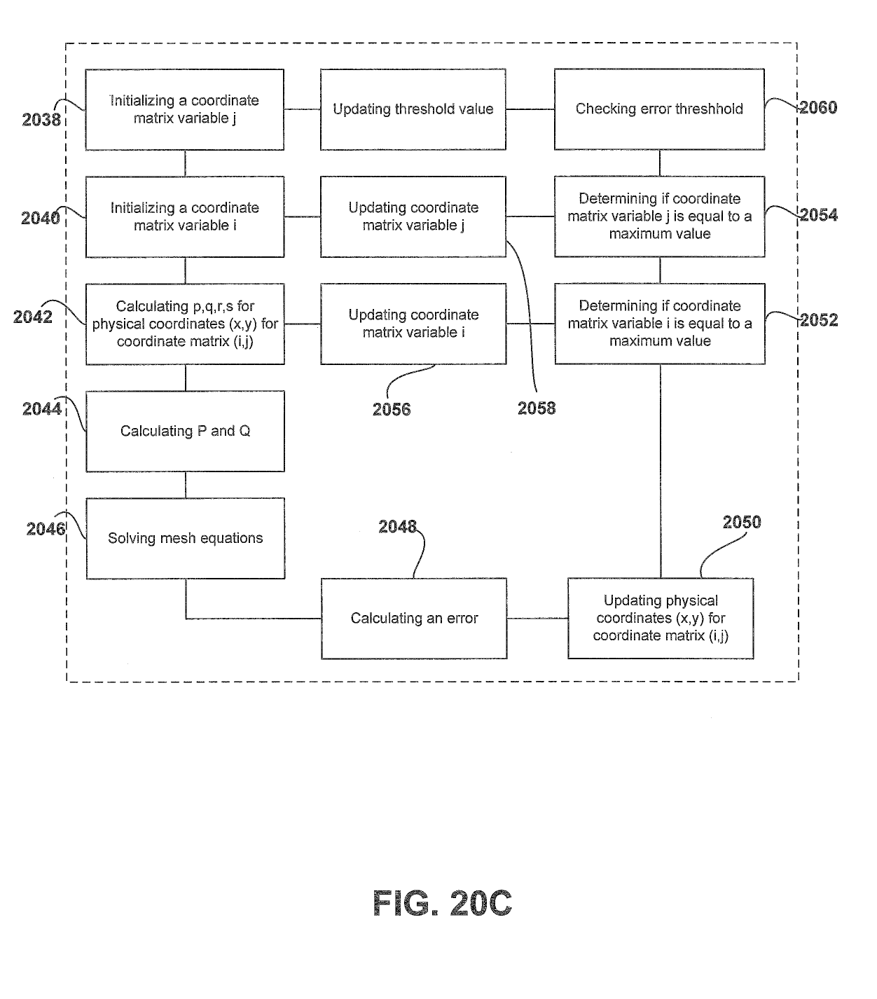

FIGS. 20A, 20B, and 20C illustrate another exemplary implementation 2000 of a method that generates a computation mesh using one or more mesh equations as described herein. Considering the mathematical techniques discussed above, method 2000, at stage 2002, includes receiving one or more inputs. An input includes, but is not limited to, a shape, a mesh parameter (e.g., M and N), a terminating criteria, a maximum number of iterations and any combination thereof. It is contemplated that method 2000 may include any number of inputs, as desired and that comports with the application and implementation of such system and or method. Accordingly, the quantity and selection of these inputs may be based on the desired functionality of a computer-implementation of a method (e.g., method 300, 2000) as described herein.

At stage 2004, method 2000 includes setting an error value. An error value can be equal to the terminating criteria, such as, for example, when the terminating criteria is equal to the difference between a first set of physical coordinates (x,y) and a second set of physical coordinates (x,y), as described above. Alternatively, an error value can be provided by the computer-implementation of a system and or method in accordance with the present disclosure. When the error value is provided, a user or user input is not required.

At stage 2006, method 2000 includes setting a maximum number of iterations. A number of iterations is used determine when method 2000 is unable to determine a suitable value for physical coordinates (x,y) so as to solve the one or more mesh equations. Like the error value, the number of iterations can be provided by the end user. In other instances, the number of iterations is provided within the computer-implementation so user input is not required.

To determine each of the physical coordinates, method 2000 can apply a step-wise approach. By incrementally increasing a computation coordinate ξ and a computation coordinate ξ, method 2000 determines the physical location (x,y) for each of the grid points in the computation mesh. At stage 2008, method 2000 includes determining the physical coordinates (x,y) for each of the grid points located along the inner and outer boundary of the computation mesh. At stage 2010, method 2000 includes setting computation coordinate η to a minimum value. The minimum value to determine the physical coordinates along the inner boundary is 1. By setting the computation coordinate η to 1, method 2000 can determine the physical coordinates (x,y) for each of the grid points proximate the inner boundary. Alternatively, by setting the computation coordinate η to a maximum value, e.g., η_{MAX}, method 2000 can determine the physical coordinates (x,y) for each of the grid points proximate the outer boundary.

As discussed above, a coordinate matrix can be used to store the calculated values of physical coordinates for each of the grid points of a computation mesh. In the present example, the coordinate matrix is a two-dimensional matrix. Each position inside the coordinate matrix is described by two variables, e.g., (i,j). At stage 2012, method 2000 includes initializing a coordinate matrix variable j. At stage 2014, method 2000 includes initializing a coordinate matrix variable i. By initializing coordinate matrix variables i and j, method 2000 sets the first storage position within the coordinate matrix for storing the physical coordinates (x,y) for the first grid point in the computation mesh.

At stage 2016, method 2000 includes initializing a computation coordinate ξ. As described above, each of the grid points in a computation mesh have a grid location defined by a set of computation coordinates (ξ,η). In the present example, in order to determine a set of physical coordinates (x,y) for the grid points along the inner and the outer boundaries, the computation coordinate η will be held constant while the computation coordinate ξ will be incremented. Accordingly, when determining physical coordinates (x,y) proximate the inner boundary, method 2000 initializes the computation coordinate ξ for the first grid points within the computation mesh, e.g., (ξ,η)=(1,1).

At stage 2018, method 2000 includes determining a physical coordinate (x,y) for a grid point having a grid location corresponding to the set of computation coordinates (ξ,η). For the grid points proximate the inner boundary, e.g., when computation coordinate η=1, method 2000 calculates the physical coordinates (x,y) by using the first-order derivate equations discussed above:

$$\begin{matrix}{[ {x}_{η} ]}_{{η}_{1}} = {[ {D}_{1} ( ξ ) \frac{- {x}_{ξ} cos θ - {y}_{ξ} sin θ}{\sqrt{{g}_{11}}} ]}_{{η}_{1}} & Equation ( 56 ) \\ {[ {y}_{η} ]}_{{η}_{1}} = {[ {D}_{1} ( ξ ) \frac{- {y}_{ξ} cos θ - {y}_{ξ} sin θ}{\sqrt{{g}_{11}}} ]}_{{η}_{1}} . & Equation ( 57 )\end{matrix}$$

For the grid points proximate the outer boundary, e.g., when computation coordinate η=η_{MAX}, method 2000 calculates the physical coordinates (x,y) by using the first-order derivate equations discussed above:

$$\begin{matrix}{[ {x}_{η} ]}_{{η}_{M}} = {[ {D}_{M} ( ξ ) \frac{- {x}_{ξ} cos θ - {y}_{ξ} sin θ}{\sqrt{{g}_{11}}} ]}_{{η}_{M}} & Equation ( 58 ) \\ {[ {y}_{η} ]}_{{η}_{M}} = {[ {D}_{M} ( ξ ) \frac{- {y}_{ξ} cos θ - {y}_{ξ} sin θ}{\sqrt{{g}_{11}}} ]}_{{η}_{M}} & Equation ( 59 )\end{matrix}$$

At stage 2020, method 2000 includes storing physical coordinates (x,y). Method 2000 stores calculated values of a first-order derivate equations (e.g., Equations 56 to 59, above) in a position within the coordinate matrix corresponding to the grid points. In the present example, when computation coordinate η=1, then each of the physical coordinates (x,y) will be stored in a position within coordinate matrix corresponding to (i, 1), wherein coordinate matrix variable i changes for each value of computation coordinate ξ. On the other hand, when computation coordinate η=η_{MAX}, then each of the physical coordinates (x,y) will be stored in a position within coordinate matrix corresponding to (i, j_{MAX}), wherein coordinate matrix variable i changes for each value of computation coordinate ξ and the value of j_{MAX} is equal the number of grid points along the ξ-grid lines (M).

At stage 2022, method 2000 includes determining if physical coordinates (x,y) for another grid point proximate the inner boundary needs to be determined. In the present example, method 2000 considers whether the value for computation coordinate ξ is equal to a maximum expected value, ξ_{MAX}. As discussed above, the maximum expected value for computation coordinate ξ can be the number of grid points along a η-grid lines (N). If the value of computation coordinate ξ is not equal to ξ_{MAX}, then method 2000, at stage 2024, includes updating the value of computation coordinate ξ to reflect the next grid point in the computation mesh. In addition, method 2000, at stage 2026, includes updating the value of coordinate matrix variable i to reflect the next position in the coordinate matrix.

If the value of computation coordinate ξ does equal ξ_{MAX}, then method 2000, at stage 2028, includes determining if physical coordinates (x,y) for another grid point proximate the outer boundary needs to be determined. In the present example, method 2000 considers whether the value for computation coordinate η is equal to a maximum expected value, η_{MAX}. As discussed above, the maximum expected value for computation coordinate ξ can be the number of grid points along a ξ-grid lines (M). If the value of computation coordinate η is not equal to η_{MAX}, then method 2000, at stage 2030, includes setting computation coordinate η=η_{MAX} to reflect grid points proximate the outer boundary. In addition, method 2000, at stage 2032, includes updating the coordinate variable j to reflect the position in the coordinate matrix that corresponds to the grid points proximate the outer boundary, e.g., j=j_{MAX}.

At stage 2034, method 2000 includes determining physical coordinates (x,y) for the remaining grid points in the computation mesh. In general, method 2000 will employ one or more interpolation techniques, such as the interpolation technique discussed above in relation to FIG. 4. Each of the values of physical coordinates (x,y) determined will be stored in the coordinate matrix. Although not discussed in detail herein, it is contemplated that the values of physical coordinates (x,y) will be stored in a coordinate matrix similar to the coordinate matrix discussed above. In one example, stage 2034 can employ techniques similar to those employed in stage 2008 discussed immediately above.

At stage 2036, method 2000 includes determining if the initial values of physical coordinates (x,y) determined in stages 2008 to 2034 satisfy the one or more mesh equations. If the initial values satisfy the mesh equations, then the values of the physical coordinates (x,y) are the final values and can be used to generate the grid of the computation mesh. In the more likely scenario, if the initial values do not satisfy the mesh equations, then an iterative method is employed to find values of physical coordinates (x,y) that satisfy the one or more mesh equations.

To find these values, method 2000 includes, at stage 2038 and at stage 2040, initializing the coordinate matrix variables i and j. As discussed above, these variables define the position within a coordinate matrix (i,j) for the physical coordinates (x,y) that correspond to the grid points of the computation mesh. For purposes of finding physical coordinates (x,y) that satisfy the one or more mesh equations, each of the physical coordinates (x,y) must be tested. Accordingly, by initializing these two variables i and j, tests the physical coordinates (x,y) stored in the first position of the coordinate matrix.

At stage 2042, method 2000 includes calculating p, q, r and s for physical coordinates (x,y) for a position in coordinate matrix (i,j). The sources p, q, r and s are used at stage 2044, where method 2000 includes determining source terms P and Q. The values for source terms P and Q correspond to the physical coordinates (x,y) for each of the grid points of the computation mesh. These source terms P and Q are incorporated at stage 2046, where method 2000 includes solving mesh equations utilizing physical coordinates (x,y) for a position in coordinate matrix (i,j), wherein the mesh equations include:

g₂₂x_{ξξ}+g₁₁x_{ηη}−2g₁₂x_{ξη}+J²(Px_{ξ}+Qx_{η})=0 Equation (60)

g₂₂y_{ξξ}+g₁₁y_{ηη}−2g₁₂y_{ξη}+J²(Py_{ξ}+Qy_{η})=0 Equation (61)

As discussed above, when solving the one or more mesh equations, method 2000 determines a value for the left side of the equation and a value for the right side of the equation for each of the physical coordinates (x,y) stored in the coordinate matrix (i,j). At stage 2048, method 2000 includes calculating an error based on these values. In one example, this error is equal to the difference between the value of the left side (e.g., H1) and the value of the right side (e.g., Z1) for each of Equations 52 and 53 above. The calculated error is assigned to an error variable. An error variable stores a calculated error. In one embodiment of method 2000, the variable is continually updated based upon error calculation for subsequent physical coordinates (x,y). Thus, in accordance with the present disclosure, if the error calculation for the present physical coordinates (x,y) is greater than the value of the error calculation for the prior physical coordinates (x,y), then the value of the error variable is updated to reflect the value of the error calculation for the present physical coordinates (x,y).

If the value of the left side does not equal the value of the rights side, then at stage 2050, method 2000 includes updating physical coordinates (x,y) for coordinate matrix location (i,j). The updated physical coordinates (x,y) can be done in a variety of ways. In one example, the value of the physical coordinates (x,y) are updated as a function of a mathematical equation. In another example, the value of the physical coordinates (x,y) are updated as a function of geometric equations.

At stages 2052 and 2054, method 2000 determines whether additional physical coordinates (x,y) must be tested, according to the stages discussed above. At stage 2052, method 2000 includes determining whether the coordinate matrix variable i is equal to a maximum value. This determination provides assurances that all of the physical coordinates (x,y) for a specified value of coordinate matrix variable j have been tested. If coordinate matrix variable i does not equal the maximum value, e.g., i_{MAX}, then at stage 2056, method 2000 includes increasing the value of i. In one example, increasing the value of i include i=i+1. If coordinate matrix variable i equals i_{MAX}, then at stage 2054, method 2000 include determine whether the coordinate matrix variable j is equal to a maximum value. This determination provides assurances that all of the physical coordinates (x,y) for a coordinate matrix (i,j) have been tested. If coordinate matrix variable j does not equal the maximum value, e.g., j_{MAX}, then at stage 2058, method 2000 includes increasing the value of j. In one example, increasing the value of j include j=j+1.

If coordinate matrix variable j equals the maximum value variable j_{MAX}, then at stage 2060, method 2000 includes checking an error threshold. An error threshold is a threshold which determines whether additional iterations of the iterative method are required. Although an error threshold can have any value, it is generally recognized that an error threshold has a value equal to the error value, mentioned above. In one implementation of 20 method 2000, stage 2060 compares the value of the error variable with the value of the error threshold. If the value of the error variable does not exceed the error threshold, then at stage 2062, method 2000 includes assigning the existing values for physical coordinates (x,y) to a final set of physical coordinates (x,y). These final set of physical coordinates (x,y) are used in stages 2066 and 2068, where method 2050 includes generating the grid of the computation mesh and displaying at least one indicia, respectively.

If the value of the error variable exceeds the error threshold, the at stage 2054, method 2000 updates the iteration value and determines another set of physical coordinates (x,y) by repeating stages 2038 to 2064. Although not discussed in detail herein, the iteration value reflects the number of iterations allowed before a method in accordance with the present disclosure will not generate a computation mesh.

In the event that a grid is not generated, additional stages may be required so as to allow a user or the computer implementation of this method to change one or more of the limited input variables.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A computer-implemented method for automatically generating a computation mesh for use with an analytical tool, the computation mesh having a plurality of ξ-grid lines and η-grid lines intersecting at grid points positioned with respect to an inner boundary and an outer boundary, the method comprising:
receiving from a user information corresponding to a shape to be analyzed using the analytical tool;
solving one or more mesh equations for a plurality of point locations, the one or more mesh equations having one or more source terms that include:
a grid clustering component based on a Jacobian scaling parameter, a source decay parameter, and one or more first point distance parameters, and
a cell shape modifying source component based on one or more source parameters selected from the group consisting of a smoothing source parameter, an area source parameter, an orthagonality source parameter, and any combinations thereof;
generating the computation mesh as a function of the plurality of point locations; and
outputting one or more indicia representing the computation mesh.

2. A method according to claim 1, wherein said solving one or more mesh equations includes defining the one or more source terms according to:
P^{(x)}=W_{S}p_{S}^{(x)}+W_{A}(y_{η}y_{ξη}−y_{ξ}y_{ηη})+W_{O}(y_{η}y_{ξη}+y_{ξ}y_{ηη})
P^{(y)}=W_{S}p_{S}^{(y)}+W_{A}(x_{η}x_{ξη-x}_{ξ}x_{ηη})+W_{O}(x_{η}x_{ξη}+x_{ξ}x_{ηη})
Q^{(x)}=W_{S}q_{S}^{(x)}+W_{A}(y_{ξ}y_{ξη}−y_{η}y_{ξξ})+W_{O}(y_{ξ}y_{ξη}+y_{η}y_{ξξ})
Q^{(y)}=W_{S}q_{S}^{(y)}+W_{A}(x_{ξ}x_{ξη}−x_{η}x_{ξξ})+W_{O}(x_{ξ}y_{ξη}+x_{η}x_{ξξ})
where P^{(x)}, P^{(y)}, Q^{(x)}, and Q^{(y)} are source terms of the one or more mesh equations;
W_{S} is a smoothing source parameter; W_{A} is an area source parameter; W_{O} is an orthagonality source parameter; and p_{S}^{(x)}, q_{S}^{(x)}, p_{S}^{(y)} and q_{S}^{(y)} are grid clustering components.

3. A method according to claim 2, wherein the smoothing, area, and orthagonality parameters have values that satisfy the equation:
0≦[W_{S},W_{A},W_{O}]≦1.

4. A method according to claim 2, wherein the smoothing source parameter has a value of 1, the area source parameter has a value of 0.5, and the orthagonality source parameter has a value of 0.15.

5. A method according to claim 2, wherein the one or more mesh equations include:
G₂₂^{(x)}x_{ξξ}+G₁₁^{(x)}x_{ηη}=2G₁₂^{(x)}x_{ξη}+(P^{(x)}x_{ξ}+Q^{(x)}x_{η})=0
G₂₂^{(y)}y_{ξξ+G}₁₁^{(y)}y_{ηη}−2G₁₂^{(y)}y_{ξη}+(P^{(y)}y_{ξ}+Q^{(y)}y_{η})=0
wherein the metric terms are defined as
G₁₁^{(x)}=W_{S}g₁₁+W_{A}y_{ξ}²+W_{O}x_{ξ}²
G₁₂^{(x)}=W_{S}g₁₂+W_{A}y_{ξ}y_{η}+W_{O}(−g₁₂−x_{ξ}x_{η})
G₂₂^{(x)}=W_{S}g₂₂+W_{A}y_{η}²+W_{O}x_{η}²
G₁₁^{(y)}=W_{S}g₁₁+W_{A}x_{ξ}²+W_{O}y_{ξ}²
G₁₂^{(x)}=W_{S}g₁₂+W_{A}x_{ξ}x_{η}+W_{O}(−g₁₂−y_{ξ}y_{η})
G₂₂^{(y)}=W_{S}g₂₂+W_{A}x_{η}²+W_{O}y_{η}²
wherein
g₁₁≡x_{ξ}²+y_{ξ}²
g₂₂≡x_{η}²+y_{η}²
g₁₂≡x_{ξ}x_{η}+y_{ξ}y_{η}
wherein W_{S} is a smoothing source parameter; W_{A} is an area source parameter;
W_{O} is an orthagonality source parameter.

6. A method according to claim 2, wherein p_{S}^{(x)}, q_{S}^{(x)}, p_{S}^{(y)} and q_{S}^{(y)} are defined according to:
p_{S}^{(x)}=p(ξ)e^{-a(ξ)(η-η}^{₁}⁾+r(ξ)e^{-b(ξ)(η}^{_{M}}^{-η)}
q_{S}^{(x)}=p(ξ)e^{-c(ξ)(η-η}^{₁}⁾+s(ξ)e^{-d(ξ)(η}^{_{M}}^{-η)}
p_{S}^{(y)}=p(ξ)e^{-a(ξ)(η-η}^{₁}⁾+r(ξ)e^{-b(ξ)(η}^{_{M}}^{-η)}
q_{S}^{(y)}=q(ξ)e^{-c(ξ)(η-η}^{₁}⁾+s(ξ)e^{-d(ξ)(η}^{_{M}}^{-η)}
where a(ξ), b(ξ), c(ξ), d(ξ) are source decay parameters defined at a value of computation coordinate ξ; p(ξ), q(ξ), r(ξ) and s(ξ) are sources; η is a number having a value of computation coordinate η; η₁ is a number having a value of η proximate the inner boundary along the ξ-grid lines; and η_{M} is a number having a value proximate the inner boundary along the ξ-grid line.

7. A method according to claim 2, wherein p_{S}^{(x)}, q_{S}^{(x)}, p_{S}^{(y)} and q_{S}^{(y)} are defined according to:
p_{S}^{(x)}=p(ξ)e^{-a(ξ)(η-η}^{₁}⁾+r(ξ)e^{-b(ξ)(η}^{_{M}}^{-η)}
q_{S}^{(x)}=p(ξ)e^{-c(ξ)(η-η}^{₁}⁾+s(ξ)e^{-d(ξ)(η}^{_{M}}^{-η)}
p_{S}^{(y)}=p(ξ)e^{-a(ξ)(η-η}^{₁}⁾+r(ξ)e^{-b(ξ)(η}^{_{M}}^{-η)}
q_{S}^{(y)}=q(ξ)e^{-c(ξ)(η-η}^{₁}⁾+s(ξ)e^{-d(ξ)(η}^{_{M}}^{-η)}
where k is a source decay factor that is proportional to a source decay parameter and inversely proportional to the number of η-grid lines of the computation mesh; p(ξ), q(ξ), r(ξ) and s(ξ) are sources; η is a number having a value of a computation coordinate η; η₁ is a number having a value of η proximate the inner boundary along the ξ-grid lines; and η_{M} is a number having a value proximate the inner boundary along the ξ-grid line.

8. A method according to claim 2, further comprising relating the grid clustering components p_{S}^{(x)}, q_{S}^{(x)}, p_{S}^{(y)} and q_{S}^{(y)} to the Jacobian scaling parameter according to:
$${J}^{2} p ( ξ ) = {{( \frac{J}{{J}_{1}} )}^{2} [ {R}_{1} \frac{{y}_{η}}{{J}_{1}} - {R}_{2} \frac{{x}_{η}}{{J}_{1}} ]}_{{η}_{1}}$$
$${J}^{2} q ( ξ ) = {{( \frac{J}{{J}_{1}} )}^{2} [ - {R}_{1} \frac{{y}_{ξ}}{{J}_{1}} + {R}_{2} \frac{{x}_{ξ}}{{J}_{1}} ]}_{{η}_{1}}$$
$${J}^{2} r ( ξ ) = {{( \frac{J}{{J}_{M}} )}^{2} [ {R}_{3} \frac{{y}_{η}}{{J}_{M}} - {R}_{4} \frac{{x}_{η}}{{J}_{M}} ]}_{{η}_{M}}$$
$${J}^{2} s ( ξ ) = {{( \frac{J}{{J}_{M}} )}^{2} [ - {R}_{3} \frac{{y}_{ξ}}{{J}_{M}} + {R}_{4} \frac{{x}_{ξ}}{{J}_{M}} ]}_{{η}_{M}}$$
where J is a Jacobian defining a cell area of a grid cell located within the interior of a grid of the computation mesh; J₁ identifies a Jacobian evaluated at the inner boundary; J_{M} identifies a Jacobian evaluated at the outer boundary; and R₁, R₂, R₃ and R₄ are functions of the first-order and second order-derivates that describe the shape of the ξ-grid lines and η-grid lines expressed as
R₁=−└g₂₂x_{ξξ}−2g₁₂x_{ξη}+g₁₁x_{ηη}┘_{η}_{₁}
R₂=−└g₂₂y_{ξξ}−2g₁₂y_{ξη}+g₁₁y_{ηη}┘_{η}_{₁}
R₃=−└g₂₂x_{ξξ}−2g₁₂x_{ξη}+g₁₁x_{ηη}┘_{η}_{_{M}}
R₄=−└g₂₂y_{ξξ}−2g₁₂y_{ξη}+g₁₁y_{ηη}┘_{η}_{_{M}}
where
g₁₁≡x_{ξ}²+y_{ξ}²
g₂₂≡x_{η}²+y_{η}²
g₁₂≡x_{ξ}x_{η}+y_{ξ}y_{η}

9. A method according to claim 2, further comprising relating the grid clustering components p_{S}^{(x)}, q_{S}^{(x)}, P_{S}^{(y)} and q_{S}^{(y)} to the Jacobian scaling parameter according to:
$${J}^{2} p ( ξ ) = {{( \frac{J}{{J}_{1}} )}^{λ} [ {R}_{1} \frac{{y}_{η}}{{J}_{1}} - {R}_{2} \frac{{x}_{η}}{{J}_{1}} ]}_{{η}_{1}}$$
$${J}^{2} q ( ξ ) = {{( \frac{J}{{J}_{1}} )}^{λ} [ - {R}_{1} \frac{{y}_{ξ}}{{J}_{1}} + {R}_{2} \frac{{x}_{ξ}}{{J}_{1}} ]}_{{η}_{1}}$$
$${J}^{2} r ( ξ ) = {{( \frac{J}{{J}_{M}} )}^{λ} [ {R}_{3} \frac{{y}_{η}}{{J}_{M}} - {R}_{4} \frac{{x}_{η}}{{J}_{M}} ]}_{{η}_{M}}$$
$${J}^{2} s ( ξ ) = {{( \frac{J}{{J}_{M}} )}^{λ} [ - {R}_{3} \frac{{y}_{ξ}}{{J}_{M}} + {R}_{4} \frac{{x}_{ξ}}{{J}_{M}} ]}_{{η}_{M}}$$
where J is a Jacobian defining a cell area of a grid cell located within the interior of a grid of the computation mesh; J₁ identifies a Jacobian evaluated at the inner boundary; J_{M} identifies a Jacobian evaluated at the outer boundary; λ identifies a Jacobian scaling parameter having a value that is not equal to two; and R₁, R₂, R₃ and R₄ are functions of the first-order and second order-derivates that describe the shape of the ξ-grid lines and η-grid lines expressed as
R₁=−└g₂₂x_{ξξ}−2g₁₂x_{ξη}+g₁₁x_{ηη}┘_{η}_{₁}
R₂=−└g₂₂y_{ξξ}−2g₁₂y_{ξη}+g₁₁y_{ηη}┘_{η}_{₁}
R₃=−└g₂₂x_{ξξ}−2g₁₂x_{ξη}+g₁₁x_{ηη}┘_{η}_{_{M}}
R₄=−└g₂₂y_{ξξ}−2g₁₂y_{ξη}+g₁₁y_{ηη}┘_{η}_{_{M}}
where
g₁₁≡x_{ξ}²+y_{ξ}²
g₂₂≡x_{η}²+y_{η}²
g₁₂≡x_{ξ}x_{η}+y_{ξ}y_{η}

10. A method according to claim 1, further comprising said first point distance parameter including an outer boundary distance parameter determined as a function of an inner boundary distance parameter and one of the natural log of the number of η-grid lines and the square root of the number of η-grid lines.

11. A system for automatically generating a computation mesh for use with an analytical tool, the computation mesh having a plurality of ξ-grid lines and η-grid lines intersecting at grid points positioned with respect to an inner boundary and an outer boundary, the system comprising:
a means for receiving from a user information corresponding to a shape to be analyzed using the analytical tool;
a means for solving one or more mesh equations for a plurality of point locations, the one or more mesh equations having one or more source terms that include:
a grid clustering component based on a Jacobian scaling parameter, a source decay parameter, and one or more first point distance parameters, and
a cell shape modifying source component based on one or more source parameters selected from the group consisting of a smoothing source parameter, an area source parameter, an orthagonality source parameter, and any combinations thereof;
a means for generating the computation mesh as a function of the plurality of point locations; and
a means for outputting one or more indicia representing the computation mesh.

12. A system according to claim 1, wherein said one or more source terms are defined according to:
P^{(x)}=W_{S}p_{S}^{(x)}+W_{A}(y_{η}y_{ξη}−y_{ξ}y_{ηη})+W_{O}(y_{η}y_{ξη}+y_{ξ}y_{ηη})
P^{(y)}=W_{S}p_{S}^{(y)}+W_{A}(x_{η}x_{ξη}−x_{ξ}x_{ηη})+W_{O}(x_{η}x_{ξη}+x_{ξ}x_{ηη})
Q^{(x)}=W_{S}q_{S}^{(x)}+W_{A}(y_{ξ}y_{ξη}−y_{η}y_{ξξ})+W_{O}(y_{ξ}y_{ξη}+y_{η}y_{ξξ})
Q^{(y)}=W_{S}q_{S}^{(y)}+W_{A}(x_{ξ}x_{ξη}−x_{η}x_{ξξ})+W_{O}(x_{ξ}y_{ξη}+x_{η}x_{ξξ})
where p^{(x)}, p^{(y)}, Q^{(x)}, and Q^{(y)} are source terms of the one or more mesh equations;
W_{S} is a smoothing source parameter; W_{A} is an area source parameter; W_{O} is an orthagonality source parameter; and p_{S}^{(x)}, q_{S}^{(x)}, p_{S}^{(y)} and q_{S}^{(y)} are grid clustering components.

13. A machine readable medium containing machine readable instructions for performing a method of automatically generating a computation mesh for use with an analytical tool, the computation mesh having a plurality of ξ-grid lines and η-grid lines intersecting at grid points positioned with respect to an inner boundary and an outer boundary, the instructions comprising:
a set of instructions for receiving from a user information corresponding to a shape to be analyzed using the analytical tool;
a set of instructions for solving one or more mesh equations for a plurality of point locations, the one or more mesh equations having one or more source terms that include:
a grid clustering component based on a Jacobian scaling parameter, a source decay parameter, and one or more first point distance parameters, and
a cell shape modifying source component based on one or more source parameters selected from the group consisting of a smoothing source parameter, an area source parameter, an orthagonality source parameter, and any combinations thereof;
a set of instructions for generating the computation mesh as a function of the plurality of point locations; and
a set of instructions for outputting one or more indicia representing the computation mesh.

14. A machine readable medium according to claim 1, wherein said solving one or more mesh equations includes defining the one or more source terms according to:
P^{(x)}=W_{S}p_{S}^{(x)}+W_{A}(y_{η}y_{ξη}−y_{ξ}y_{ηη})+W_{O}(y_{η}y_{ξη}+y_{ξ}y_{ηη})
P^{(y)}=W_{S}p_{S}^{(y)}+W_{A}(x_{η}x_{ξη}−x_{ξ}x_{ηη})+W_{O}(x_{η}x_{ξη}+x_{ξ}x_{ηη})
Q^{(x)}=W_{S}q_{S}^{(x)}+W_{A}(y_{ξ}y_{ξη}−y_{η}y_{ξξ})+W_{O}(y_{ξ}y_{ξη}+y_{η}y_{ξξ})
Q^{(y)}=W_{S}q_{S}^{(y)}+W_{A}(x_{ξ}x_{ξη}−x_{η}x_{ξξ})+W_{O}(x_{ξ}y_{ξη}+x_{η}x_{ξξ})
where P^{(x)}, P^{(y)}, Q^{(x)}, and Q^{(y)} are source terms of the one or more mesh equations;
W_{S} is a smoothing source parameter; W_{A} is an area source parameter; W_{O} is an orthagonality source parameter; and p_{S}^{(x)}, q_{S}^{(x)}, p_{S}^{(y)} and q_{S}^{(y)} are grid clustering components.

15. A machine readable medium according to claim 2, wherein the smoothing, area, and orthagonality parameters have values that satisfy the equation:
0≦[W_{S},W_{A},W_{O}]≦1.

16. A machine readable medium according to claim 2, wherein the smoothing source parameter has a value of 1, the area source parameter has a value of 0.5, and the orthagonality source parameter has a value of 0.15.

17. A machine readable medium according to claim 2, wherein the one or more mesh equations include:
G₂₂^{(x)}x_{ξξ}+G₁₁^{(x)}x_{ηη}=2G₁₂^{(x)}x_{ξη}+(P^{(x)}x_{ξ}+Q^{(x)}x_{η})=0
G₂₂^{(y)}y_{ξξ+G}₁₁^{(y)}y_{ηη}−2G₁₂^{(y)}y_{ξη}+(P^{(y)}y_{ξ}+Q^{(y)}y_{η})=0
wherein the metric terms are defined as
G₁₁^{(x)}=W_{S}g₁₁+W_{A}y_{ξ}²+W_{O}x_{ξ}²
G₁₂^{(x)}=W_{S}g₁₂+W_{A}y_{ξ}y_{η}+W_{O}(−g₁₂−x_{ξ}x_{η})
G₂₂^{(x)}=W_{S}g₂₂+W_{A}y_{η}²+W_{O}x_{η}²
G₁₁^{(y)}=W_{S}g₁₁+W_{A}x_{ξ}²+W_{O}y_{ξ}²
G₁₂^{(y)}=W_{S}g₁₂+W_{A}x_{ξ}x_{η}+W_{O}(−g₁₂−y_{ξ}y_{η})
G₂₂^{(y)}=W_{S}g₂₂+W_{A}x_{η}²+W_{O}y_{η}²
wherein
g₁₁≡x_{ξ}²+y_{ξ}²
g₂₂≡x_{η}²+y_{η}²
g₁₂≡x_{ξ}x_{η}+y_{ξ}y_{η}
wherein W_{S} is a smoothing source parameter; W_{A} is an area source parameter;
W_{O} is an orthagonality source parameter.

18. A machine readable medium according to claim 2, wherein p_{S}^{(x)}, q_{S}^{(x)}, p_{S}^{(y)} and q_{S}^{(y)} are defined according to:
p_{S}^{(x)}=p(ξ)e^{-a(ξ)(η-η}^{₁}⁾+r(ξ)e^{-b(ξ)(η}^{_{M}}^{-η)}
q_{S}^{(x)}=p(ξ)e^{-c(ξ)(η-η}^{₁}⁾+s(ξ)e^{-d(ξ)(η}^{_{M}}^{-η)}
p_{S}^{(y)}=p(ξ)e^{-a(ξ)(η-η}^{₁}⁾+r(ξ)e^{-b(ξ)(η}^{_{M}}^{-η)}
q_{S}^{(y)}=q(ξ)e^{-c(ξ)(η-η}^{₁}⁾+s(ξ)e^{-d(ξ)(η}^{_{M}}^{-η)}
where k is a source decay factor that is proportional to a source decay parameter and inversely proportional to the number of η-grid lines of the computation mesh; p(ξ), q(ξ), r(ξ) and s(ξ) are sources; η is a number having a value of a computation coordinate η; η₁ is a number having a value of η proximate the inner boundary along the ξ-grid lines; and η_{M} is a number having a value proximate the inner boundary along the ξ-grid line.

19. A machine readable medium according to claim 2, further comprising a set of instructions relating the grid clustering components p_{S}^{(x)}, q_{S}^{(x)}, p_{S}^{(y)} and q_{S}^{(y)} to the Jacobian scaling parameter according to:
$${J}^{2} p ( ξ ) = {{( \frac{J}{{J}_{1}} )}^{λ} [ {R}_{1} \frac{{y}_{η}}{{J}_{1}} - {R}_{2} \frac{{x}_{η}}{{J}_{1}} ]}_{{η}_{1}}$$
$${J}^{2} q ( ξ ) = {{( \frac{J}{{J}_{1}} )}^{λ} [ - {R}_{1} \frac{{y}_{ξ}}{{J}_{1}} + {R}_{2} \frac{{x}_{ξ}}{{J}_{1}} ]}_{{η}_{1}}$$
$${J}^{2} r ( ξ ) = {{( \frac{J}{{J}_{M}} )}^{λ} [ {R}_{3} \frac{{y}_{η}}{{J}_{M}} - {R}_{4} \frac{{x}_{η}}{{J}_{M}} ]}_{{η}_{M}}$$
$${J}^{2} s ( ξ ) = {{( \frac{J}{{J}_{M}} )}^{λ} [ - {R}_{3} \frac{{y}_{ξ}}{{J}_{M}} + {R}_{4} \frac{{x}_{ξ}}{{J}_{M}} ]}_{{η}_{M}}$$
where J is a Jacobian defining a cell area of a grid cell located within the interior of a grid of the computation mesh; J₁ identifies a Jacobian evaluated at the inner boundary; J_{M} identifies a Jacobian evaluated at the outer boundary; λ identifies a Jacobian scaling parameter having a value that is not equal to two; and R₁, R₂, R₃ and R₄ are functions of the first-order and second order-derivates that describe the shape of the ξ-grid lines and η-grid lines expressed as
R₁=−└g₂₂x_{ξξ}−2g₁₂x_{ξη}+g₁₁x_{ηη}┘_{η}_{₁}
R₂=−└g₂₂y_{ξξ}−2g₁₂y_{ξη}+g₁₁y_{ηη}┘_{η}_{₁}
R₃=−└g₂₂x_{ξξ}−2g₁₂x_{ξη}+g₁₁x_{ηη}┘_{η}_{_{M}}
R₄=−└g₂₂y_{ξξ}−2g₁₂y_{ξη}+g₁₁y_{ηη}┘_{η}_{_{M}}
where
g₁₁≡x_{ξ}²+y_{ξ}²
g₂₂≡x_{η}²+y_{η}²
g₁₂≡x_{ξ}x_{η}+y_{ξ}y_{η}

20. A machine readable medium according to claim 1, further comprising said first point distance parameter including an outer boundary distance parameter determined as a function of an inner boundary distance parameter and one of the natural log of the number of η-grid lines and the square root of the number of η-grid lines.
